(19) United States
(12) Patent Application Publication
(10) Pub. No.: US 2025/0213985 A1
(43) Pub. Date: Jul. 3, 2025

(54) METHOD AND DEVICE FOR CONTROLLING MOTION OF USER CHARACTER

(71) Applicant: NCSOFT Corporation, Seoul (KR)

(72) Inventor: Taeyong CHOI, Seoul (KR)

(73) Assignee: NCSOFT Corporation, Seoul (KR)

(21) Appl. No.: 19/084,094

(22) Filed: Mar. 19, 2025

Related U.S. Application Data
(63) Continuation of application No. PCT/KR2023/016421, filed on Oct. 20, 2023.

(51) Int. Cl. A63F 13/69; A63F 13/58; A63F 13/80

(52) U.S. Cl. CPC A63F 13/69; A63F 13/58; A63F 13/80

(57) ABSTRACT

The present disclosure relates to a method and device for controlling a motion of a user character. According to an embodiment of the present disclosure, there may be provided a method of controlling a motion of a user character, the method including: determining whether a condition for a jump motion of the user character is satisfied; based on determining that the condition for the jump motion of the user character is satisfied, activating a jump motion input object and determining whether the user character is jumping; and based on determining that the user character is jumping, activating a jump attack motion input object, wherein the condition for the jump motion includes that the user character is airborne.

### CROSS-REFERENCE TO RELATED APPLICATIONS

This application is a Continuation Application of International Application PCT/KR2023/016421 filed on Oct. 20, 2023, at the Korean Intellectual Property Office, the disclosures of which are incorporated herein in its entirety by reference.

### TECHNICAL FIELD

The present disclosure relates to a method and device for controlling a motion of a user character.

### BACKGROUND ART

Battle royale games, in which multiple players engage in repeated combat until a single survivor emerges victorious, have gained popularity from gamers from the past to the present, and various battle royale games have constantly been released.

However, many battle royale games induce combat by shrinking the area in which combat takes place, and similar methods are usually applied to this.

Accordingly, there is a need to introduce new gameplay methods or motions of user characters that may attract the interest of users who play battle royale games.

### SUMMARY

The present disclosure is to provide a method and device for controlling a motion of a user character. Technical objectives of the present disclosure are not limited to the foregoing, and other unmentioned objects or advantages of the present disclosure would be understood from the following description and be more clearly understood from the embodiments of the present disclosure. In addition, it would be appreciated that the objectives and advantages of the present disclosure may be implemented by means provided in the claims and a combination thereof.

A first aspect of the present disclosure may provide a method of controlling a motion of a user character, the method including: determining whether a condition for a jump motion of the user character is satisfied; based on determining that the condition for the jump motion of the user character is satisfied, activating a jump motion input object and determining whether the user character is jumping; and based on determining that the user character is jumping, activating a jump attack motion input object, wherein the condition for the jump motion includes that the user character is airborne.

A second aspect of the present disclosure may provide a device for controlling a motion of a user character, the device including: a memory storing at least one program; and a processor configured to execute the at least one program to perform an operation, wherein the processor is further configured to determine whether a condition for a jump motion of the user character is satisfied, activate, based on determining that the condition for the jump motion of the user character is satisfied, a jump motion input object and determine whether the user character is jumping, and activate, based on determining that the user character is jumping, a jump attack motion input object, wherein the condition for the jump motion includes that the user character is airborne.

A third aspect of the present disclosure may provide a computer-readable recording medium having recorded thereon a program for causing a computer to execute the method according to the first aspect.

According to an embodiment of the present disclosure, by reshaping the area where combat takes place in various ways, it is possible to provide a new experience to users playing the game and to enhance gameplay satisfaction.

Furthermore, by introducing new motions, it is possible to prevent elimination in the game due to mistakes or to enable new and unique types of in-game combat.

### DESCRIPTION OF DRAWINGS

FIG. 1 is a diagram illustrating an example of a system including a user terminal and a game server.

FIG. 2 is a diagram for describing a process of determining an approximate location where a user character starts a game, according to an embodiment of the present disclosure.

FIG. 3 is a diagram for describing a process of determining a detailed location where a user character starts a game, according to an embodiment of the present disclosure.

FIG. 4 is a diagram for describing a process in which a safe zone tile is converted into an unsafe zone tile, according to an embodiment of the present disclosure.

FIG. 5 is a diagram for describing a process in which safe zone tiles are destroyed as an in-game time elapses, according to an embodiment of the present disclosure.

FIG. 6 is a diagram for describing a process in which safe zone tiles are destroyed based on the density of game objects, according to an embodiment of the present disclosure.

FIG. 7 is a flowchart for describing a process of controlling a motion associated with a jump of a user character, according to an embodiment of the present disclosure.

FIG. 8 is a flowchart for describing a process of controlling a consecutive attack motion of a user character, according to an embodiment of the present disclosure.

FIG. 9 is a diagram for describing an interface provided to a user, according to an embodiment of the present disclosure.

FIG. 10 is a diagram for describing a display effect corresponding to attribute information of an in-game object, according to an embodiment of the present disclosure.

FIG. 11 is a diagram for describing a predetermined viewpoint according to an embodiment of the present disclosure.

FIG. 12 is a diagram for describing a first interface when another character that is not in an ally state with a user character is located inside a cloaking object, according to an embodiment of the present disclosure.

FIG. 13 is a diagram for describing a second interface that displays a character icon corresponding to another character that is not in an ally state with a user character, according to an embodiment of the present disclosure.

FIG. 14 is a diagram for describing a process of applying an item to a user character, according to an embodiment of the present disclosure.

FIG. 15 is a diagram for describing a process of connecting a user to a voice chat channel, according to an embodiment of the present disclosure.

FIG. 16 is a diagram for describing a user setting interface for receiving a user setting input, according to an embodiment of the present disclosure.

FIG. 17 is an example of a method of controlling a motion of a user character, according to an embodiment of the present disclosure.

FIG. 18 is a block diagram of a device for controlling a motion of a user character, according to an embodiment of the present disclosure.

### DETAILED DESCRIPTION

A method according to an embodiment of the present disclosure may include: determining whether a condition for a jump motion of a user character is satisfied; based on determining that the condition for the jump motion of the user character is satisfied, activating a jump motion input object and determining whether the user character is jumping; and based on determining that the user character is jumping, activating a jump attack motion input object. Here, the condition for the jump motion may include that the user character is airborne.

Advantages and features of the present disclosure and a method for achieving them will be apparent with reference to embodiments of the present disclosure described below together with the attached drawings. The present disclosure may, however, be embodied in many different forms and should not be construed as being limited to the embodiments set forth herein, and all changes, equivalents, and substitutes that do not depart from the spirit and technical scope of the present disclosure are encompassed in the present disclosure.

Terms used herein are for describing particular embodiments and are not intended to limit the scope of the present disclosure. The singular expression also includes the plural meaning as long as it does not inconsistent with the context. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Some embodiments of the present disclosure may be represented by functional block components and various processing operations. Some or all of the functional blocks may be implemented by any number of hardware and/or software elements that perform particular functions. For example, the functional blocks of the present disclosure may be embodied by at least one microprocessor or by circuit components for a certain function. In addition, for example, the functional blocks of the present disclosure may be implemented by using various programming or scripting languages. The functional blocks may be implemented by using various algorithms executable by one or more processors. In addition, the present disclosure may employ known technologies for electronic settings, signal processing, and/or data processing. Terms such as “mechanism”, “element”, “unit”, or “component” are used in a broad sense and are not limited to mechanical or physical components.

In addition, connection lines or connection members between components illustrated in the drawings are merely exemplary of functional connections and/or physical or circuit connections. Various alternative or additional functional connections, physical connections, or circuit connections between components may be present in a practical device.

Hereinafter, an operation performed by a user may refer to an operation performed by the user through a user terminal. For example, a command corresponding to an action performed by the user may be input to the user terminal through an input device (e.g., a keyboard or a mouse) embedded in or additionally connected to the user terminal. As another example, a command corresponding to an action performed by the user may be input to the user terminal through a touch screen of the user terminal. Here, the action performed by the user may include a certain gesture. For example, gestures may include tap, touch and hold, double-tap, drag, panning, flick, drag and drop, and the like.

Hereinafter, the present disclosure will be described in detail with reference to the accompanying drawings.

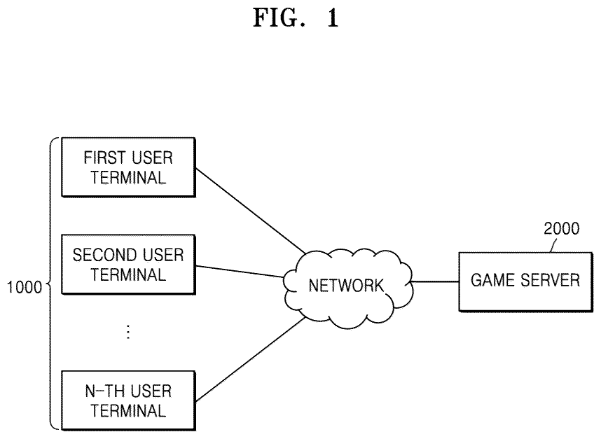

FIG. 1 is a diagram illustrating an example of a system including a user terminal and a game server.

The system according to an embodiment may include a plurality of user terminals 1000 and a game server 2000.

The user terminals 1000 may communicate with each other or with other nodes via a network.

The user terminal 1000 may be a smart phone, a tablet personal computer (PC), a PC, a smart television (TV), a mobile phone, a laptop, and other mobile or non-mobile computing devices. In addition, the user terminal 1000 may be a wearable device having a communication function and a data processing function, such as glasses or hair bands. The user terminal 1000 may include all types of devices capable of communicating with other devices via a network.

For example, the user terminal 1000 may include a touch screen, i.e., a touch input unit. The touch screen refers to a screen on which certain information may be input through a gesture of a user, and examples of gestures of the user may include tap, double tap, press (touch-and-hold), long press, drag, panning, flick, drag-and-drop, release, and the like.

The game server 2000 may be implemented as a computer device or a plurality of computer devices that provide a command, code, a file, content, a service, and the like by performing communication through a network.

The user terminals 1000 and the game server 2000 may perform communication by using a network. The game server 2000 may exchange game data with the user terminal 1000 via a network, providing a system that allows a user to play a game through the user terminal 1000.

The user terminal 1000 may access the game server 2000 through a game application and a game execution program installed on the user terminal 1000. In addition, the user terminal 1000 may access the game server 2000 through a web-based game streaming platform. However, the method of accessing the game server 2000 is not limited thereto.

Game data may include information about a user character. The information about the user character may include, for example, image information about the user character, location information about the user character, level information about the user character, information about a skill of the user character, information about an item possessed by the user character, status information about the user character such as health, mana, or stamina of the user character, and the like.

The game data may include map information. The map information may include, for example, information about safe zones and unsafe zones to be described below. The map information may include, for example, information about the terrain of tiles constituting a map, information about the design of the tiles, and the like.

The network may include a local area network (LAN), a wide area network (WAN), a value-added network (VAN), a mobile radio communication network, a satellite communication network, and a combination thereof, may be a comprehensive data communication network that allows each network constituent entity illustrated in FIG. 1 to perform seamless communication with each other, and may include a wired Internet network, a wireless Internet network, and a mobile wireless communication network. In addition, the wireless communication may include, but is not limited to, a wireless LAN (e.g., Wi-Fi), Bluetooth, Bluetooth Low Energy, Zigbee, Wi-Fi Direct (WFD), ultra-wideband (UWB), Infrared Data Association (IrDA), and near-field communication (NFC).

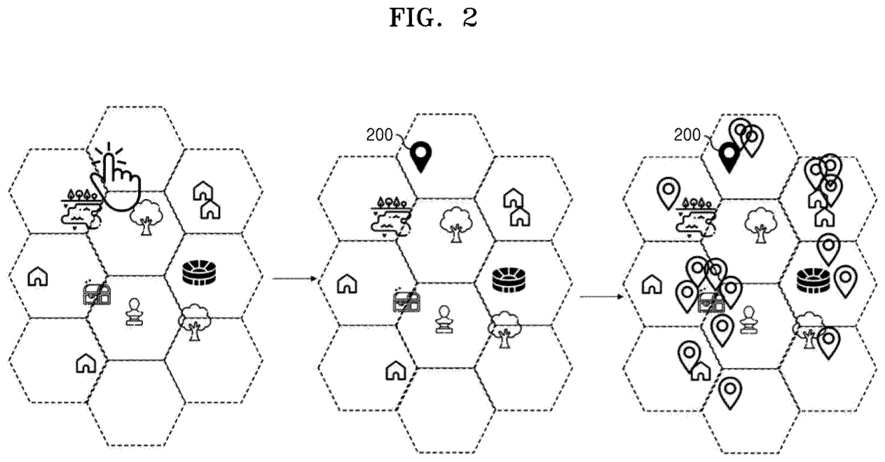

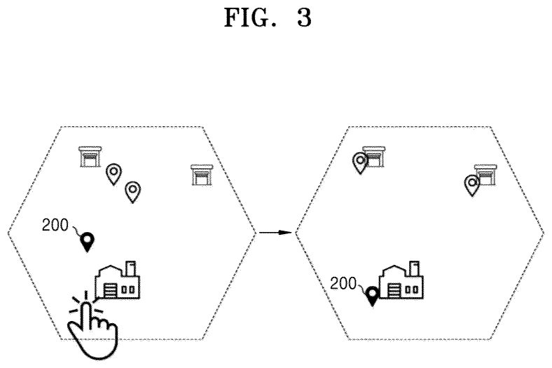

Hereinafter, a process of determining a starting point at the beginning of a game, according to various embodiments of the present disclosure will be described with reference to FIGS. 2 and 3.

In the present disclosure, the term ‘starting point’ may refer to a location where a user character starts a game. In the present disclosure, the user may determine the location where his/her character starts the game. Thus, each of a plurality of users playing the game together may freely determine the location where his/her character starts the game.

In an embodiment, the starting point may be determined according to a designation by the user. In the present disclosure, the designation of the starting point may include a primary designation that determines an approximate location where the user character starts the game, and a secondary designation that determines a detailed location where the user character starts the game. The primary designation and the secondary designation may be performed by user input.

FIG. 2 is a diagram for describing a process of determining an approximate location where a user character starts a game, according to an embodiment of the present disclosure.

As described above, the user may determine the approximate location where the user character starts the game, through the first designation.

Referring to FIG. 2, in an embodiment, a world map may be displayed to the user for the primary designation. The world map may refer to a map that represents the entire space where the game takes place.

FIG. 2 illustrates that the world map is composed of a plurality of unit areas having a hexagonal shape, and these unit areas serve to divide and identify each section of the world map and may not be identical to ‘tiles’ that will be described below. Preferably, this unit area may refer to an area significantly larger than a ‘tile’, and may be understood to include a large number of ‘tiles’.

In an embodiment, the world map may include map elements to assist the user in determining the starting point. For example, the map elements may include objects that indicate at least some of elements of the entire space where the game takes place. For example, the map elements may include objects that indicate major buildings, major geographic features, major item boxes, or the like.

FIG. 2 illustrates a world map, which may include various map elements configured as objects. For example, through the world map of FIG. 2, the user may recognize that a tree terrain exists at a particular location. For example, through the world map of FIG. 2, the user may recognize that a house exists at a particular location. For example, through the world map of FIG. 2, the user may recognize that a box from which a high-grade item may be obtained exists at a particular location.

In an embodiment, the user may designate an arbitrary location within the world map (i.e., the primary designation). When the user designates an arbitrary location within the world map, an approximate location where the user character starts the game may be determined. For example, the user may perform the primary designation by inputting a selection of an arbitrary location within the world map (e.g., a particular key input, click, or touch).

The first diagram of FIG. 2 illustrates that the user performs the primary designation by inputting a selection of a particular location within the world map (e.g., a particular key input, click, or touch). The second diagram of FIG. 2 illustrates that a first object 200, which corresponds to the location designated by the user, is displayed in response to the first designation.

In an embodiment, a preset time limit may be imposed on the primary designation. For example, the user may be required to complete the primary designation within a preset time period after the world map of FIG. 2 is displayed. When the user does not complete the primary designation even after the preset time period has elapsed, the approximate location where the user character starts the game may be randomly determined.

In an embodiment, even when the user has performed the primary designation, it may be possible to modify the primary designation within the preset time period. When the preset time period elapses, the primary designation may finally be completed.

In an embodiment, in response to the completion of the primary designation, a result of the primary designation may be displayed on the world map. In an embodiment, results of primary designations for respective users may be displayed as objects corresponding to locations selected in the primary designations. The results of the primary designations may pertain to all users participating in the game. Based on the world map displaying the results of the primary designations, the users may devise game strategies or perform secondary designations.

In an embodiment, the objects corresponding to the locations selected in the primary designations may be displayed in different manners to allow the users to distinguish between the locations they designated and the locations designated by other users.

The third diagram of FIG. 2 illustrates the world map after the primary designations are completed. Referring to the third diagram of FIG. 2, the world map may include all objects corresponding to the locations designated by all users. In addition, referring to the third diagram of FIG. 2, through the world map after the primary designations are completed, the user may check the first object 200, which corresponds to the location designated by the user, and objects that correspond to the locations designated by the other users and are displayed differently from the first object 200.

In addition, in an embodiment, the objects corresponding to the locations selected in the primary designations may include appearances based on the types of characters selected by the respective users. The user may devise a strategy based on the types of other user characters near his/her user character.

In addition, in an embodiment, the objects corresponding to the locations selected in the primary designations may be displayed based on teams to which the users belong. For example, objects corresponding to locations specified by other users belonging to the same team as the user character may be displayed in blue, and objects corresponding to locations specified by other users belonging to different teams from the user character may be displayed in red, such that the objects may be displayed differently according to their relationship to the user character. The user may devise a strategy based on the teams to which other user characters near his/her user character belong.

FIG. 3 is a diagram for describing a process of determining a detailed location where a user character starts a game, according to an embodiment of the present disclosure.

As described above, the user may determine a detailed location where the user character starts the game, through the secondary designation.

Referring to FIG. 3, in an embodiment, a magnified world map may be displayed to the user for the secondary designation. The magnified world map may refer to a map where the area on the world map corresponding to the primary designation is magnified and displayed. Through the magnified world map, the user may determine the detailed location where the user character starts the game.

In an embodiment, the magnified world map may include map elements that were not displayed in the world map. That is, the magnified world map may provide more detailed information about a particular area than the world map. FIG. 3 illustrates that objects that were not displayed in FIG. 2 are displayed on a magnified world map along with the first object 200.

In an embodiment, the user may designate an arbitrary location within the magnified world map (i.e., a secondary designation). When the user designates an arbitrary location within the magnified world map, a detailed location where the user character starts the game may be determined. For example, the user may perform the secondary designation by inputting a selection of an arbitrary location within the magnified world map (e.g., a particular key input, click, or touch).

The left diagram of FIG. 3 illustrates that the user performs the secondary designation by inputting a selection of a particular location within the magnified world map (e.g., a particular key input, click, or touch).

The right diagram of FIG. 3 illustrates that the position of the first object 200 has changed according to the secondary designation by the user. That is, in the left diagram of FIG. 3, the user may select an area around an object representing a factory (e.g., through a specific key input, click, or touch), to change the location where the user character starts the game to be closer to the object representing the factory. In response to this selection, the position of the first object 200 may be changed.

For example, the user may perform the secondary designation to a location close to a factory, which is indicated by a certain object, in order to find better items than other users or to secure a strategically advantageous position over other users.

The right diagram of FIG. 3 illustrates that the positions of objects corresponding to locations designated by other users have also changed according to secondary designations by other users.

In an embodiment, a preset time limit may be imposed on the secondary designation. For example, the user may be required to complete the secondary designation within a preset time period after the magnified world map of FIG. 3 is displayed.

In addition, in an embodiment, unlike the primary designation, the secondary designation may have restrictions on location selection. The restrictions may be imposed based on the location selected in the primary designation. In other words, the secondary designation may be understood as a modification of the primary designation, and the modification of the primary designation may only be possible within limits that are set based on the primary designation.

For example, in the left diagram of FIG. 3, when the user designates an arbitrary location within the magnified world map, the first object 200 may not immediately move to the designated location, but may gradually move toward the designated location at a constant speed. For example, the constant speed may correspond to the movement speed of the user character. The right diagram of FIG. 3 may illustrate the objects corresponding to the locations designated by the users gradually moving.

As described above, in an embodiment, a preset time limit may be imposed on the secondary designation, and when the preset time limit imposed on the secondary designation elapses while the first object 200 corresponding to the user character is gradually moving toward the designated location, the position of the first object 200 at the time when the preset time limit imposed on the secondary designation elapses may be determined as the location selected in the secondary designation.

Hereinafter, various game components associated with motions of a user character according to various embodiments of the present disclosure will be described. Various embodiments to be described below may be performed by a device for controlling a motion of a user character, and specifically, may be executed by a processor included in the device for controlling a motion of a user character.

In the present disclosure, a motion of a user character may be controlled based on whether the character is in a safe zone or an unsafe zone.

In the present disclosure, a safe zone and an unsafe zone may each be composed of one or more tiles, wherein the safe zone refers to an area that includes tiles on which a user character is able to stand without any manipulation, and the unsafe zone refers to an area that includes tiles on which a user character is unable to stand without any manipulation. As will be described below, a tile included in a safe zone may be converted into an unsafe zone when destroyed. In addition, a tile on which a user character cannot stand without any manipulation may refer to, for example, an area where the position of a user character changes in the absence of user input, or may refer to an area located a preset height or higher above the ground surface in the height axis of the game map (e.g., the z-axis).

In addition, in an embodiment, the safe zone may include an incomplete safe zone. The incomplete safe zone may refer to an area that continuously depletes the stamina of a user character located therein. For example, the incomplete safe zone may include a water surface. That is, the incomplete safe zone may be composed of one or more tiles of water surfaces. The water surface refers to a terrain composed of water within the game, and when a user character is on a water surface, the user character does not immediately fall or get eliminated from the game, but the stamina of the user character is continuously consumed, and when the stamina of the user character is completely depleted and the user character is still on the water surface, the user character may be eliminated from the game.

In the present disclosure, the map of the game may include a safe zone and an unsafe zone. In an embodiment, an initial safe zone and an initial unsafe zone may be generated when the map is initially generated. The generated initial safe zone may be set as a safe zone, and the generated initial unsafe zone may be set as an unsafe zone. A safe zone may be gradually converted into an unsafe zone according to various embodiments of the present disclosure. That is, as the game progresses, the safe zone may be gradually reduced, and the unsafe zone may gradually expand.

In the present disclosure, the term ‘tile’ may refer to a unit that constitutes a map where combat between user characters takes place in the game. Tiles may be the basic units that designers may use to design a map of the game, and may also serve as elements to enhance fun and excitement for users playing the game. In addition, tiles may be units of tile destruction, which is a method of restricting a combat area according to various embodiments to be described below.

In the following description or drawings, tiles are depicted as being flat, but may include structures with heights on the tiles (e.g., trees or statues) or designs that may impart a sense of realism (e.g., a dirt surface or a grass surface). In addition, in the following description or drawings, tiles are depicted as having a hexagonal shape or a hexagonal prism shape, but may have other shapes (e.g., a quadrangular shape or a quadrangular prism shape).

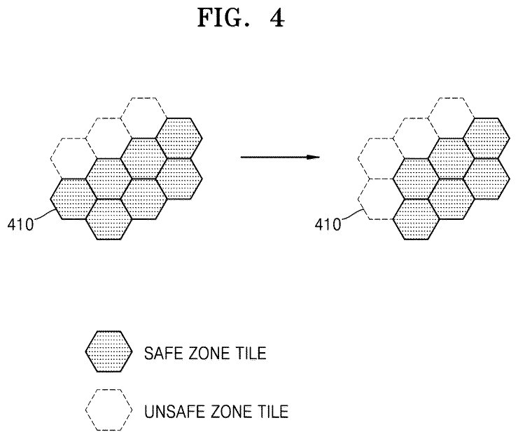

FIG. 4 is a diagram for describing a process in which a safe zone tile is converted into an unsafe zone tile, according to an embodiment of the present disclosure.

Although FIG. 4 illustrates a game map as a two-dimensional plane for convenience of description, a game map may be configured as a three-dimensional space depending on the implementation. In a case in which the game map is configured as a three-dimensional space, the tiles illustrated in FIG. 4 may be considered to be included in a plane parallel to a ground surface (e.g., an x-y plane) in the game.

In the present disclosure, a safe zone tile may refer to a tile constituting a safe zone, and an unsafe zone tile may refer to a tile constituting an unsafe zone.

In an embodiment, a user character may stand on a safe zone tile without any manipulation. That is, a safe zone tile may include a ‘ground surface’. In contrast, in an embodiment, a user character cannot stand on an unsafe zone tile without any manipulation. That is, an unsafe zone tile may not include a ‘ground surface’. In a case in which a game map is configured as a three-dimensional space, it may be designed such that when the height of a user character in the height axis direction (e.g., the z-axis) of the game map is less than or equal to a threshold value, the user character is eliminated from the game, and safe zone tiles may include a ‘ground surface’ that prevents a user character from falling, whereas unsafe zone tiles may not include a ‘ground surface’ such that a user character cannot be prevented from falling.

In addition, as described above, a safe zone may include an incomplete safe zone, and a safe zone tile may include an incomplete safe zone tile. An incomplete safe zone tile may include a ‘water surface’.

In the present disclosure, a safe zone tile may be converted into an unsafe zone tile.

FIG. 4 illustrates examples of safe zone tiles included in a safe zone and unsafe zone tiles included in an unsafe zone. The left diagram of FIG. 4 corresponds to a state before a first tile 410 is converted into an unsafe zone tile, and the right diagram of FIG. 4 corresponds to a state after the first tile 410 is converted into an unsafe zone tile.

In the present disclosure, at least some of a plurality of safe zone tiles included in a safe zone may be converted into unsafe zone tiles. FIG. 4 illustrates an example in which the first tile 410 among a plurality of safe zone tiles is converted into an unsafe zone tile. In an embodiment, the first tile 410 may be converted into an unsafe zone tile when destroyed, and as will be described below, various destruction methods may be applied. Hereinafter, that a safe zone tile is destroyed may mean that the safe zone tile is converted into an unsafe zone tile.

FIG. 4 is provided as an example, and the number of tiles that are simultaneously converted into unsafe zone tiles, the shape of the tiles, and the like, may be designed in any suitable manner.

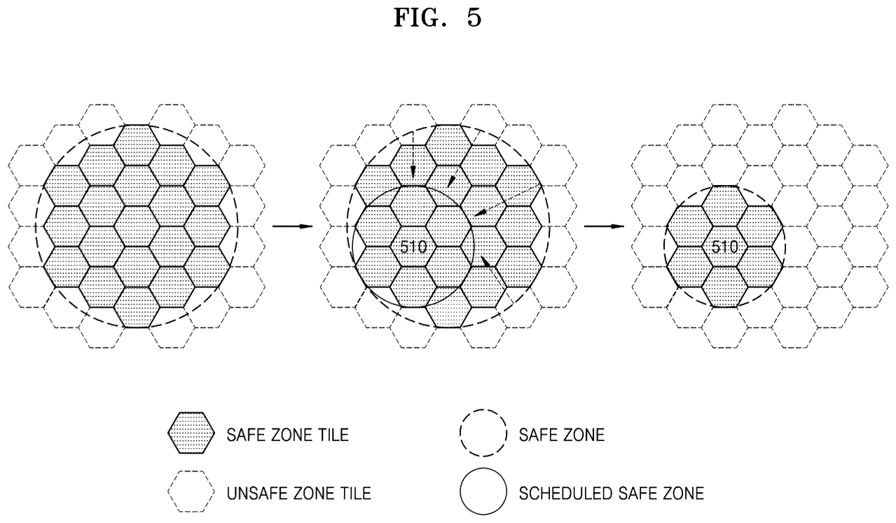

FIG. 5 is a diagram for describing a process in which safe zone tiles are destroyed as an in-game time elapses, according to an embodiment of the present disclosure.

Although FIG. 5 illustrates a game map as a two-dimensional plane for convenience of description, a game map may be configured as a three-dimensional space depending on the implementation. In a case in which the game map is configured as a three-dimensional space, the safe zones and tiles illustrated in FIG. 5 may be considered to be included in a plane parallel to a ground surface (e.g., an x-y plane) in the game.

In the present disclosure, safe zone tiles may be destroyed as the in-game time elapses.

Hereinafter, for convenience of description, the destruction of safe zone tiles as the in-game time elapses is referred to as time-based tile destruction.

In the present disclosure, time-based tile destruction may be used as a method of restricting an area in which user characters are able to perform activities in a battle royale game. That is, the location where combat takes place is reduced as the in-game time elapses, so as to create an environment where users cannot avoid combat. The time-based tile destruction of the present disclosure may provide a more thrilling experience and intuitive visual effects compared to existing battle royale games.

The first diagram of FIG. 5 illustrates safe zone tiles and unsafe zone tiles before time-based tile destruction begins. Referring to the first diagram of FIG. 5, tiles included in the safe zone indicated by the bold dotted line may correspond to safe zone tiles, and tiles that are not safe zone tiles may correspond to unsafe zone tiles. In an embodiment, a tile that is not completely included in a safe zone may be considered as an unsafe zone tile. However, as will be described below, in some embodiments, unsafe zone tiles may also be included in a safe zone. That is, a safe zone may include an unsafe zone.

In an embodiment, any one of a plurality of safe zone tiles included in a safe zone may be determined as a reduction center tile. The determination of a reduction center tile may be made by any suitable method. For example, the reduction center tile may be determined randomly. The reduction center tile may serve as a reference for time-based tile destruction.

The second diagram of FIG. 5 illustrates that a second tile 510 is determined as a reduction center tile. The second tile 510 may serve as a reference for time-based tile destruction in the illustrated example.

In an embodiment, a scheduled safe zone may be set based on the reduction center tile. In an embodiment, the scheduled safe zone may have a circular shape centered on the reduction center tile and having a preset radius. In an embodiment, the length of the radius may be set appropriately according to the elapsed game time. Preferably, the scheduled safe zone may be set to be included in the safe zone.

The second diagram of FIG. 5 illustrates a circular safe zone set centered on the second tile 510 that is the reduction center tile.

In an embodiment, the safe zone may be reduced to the scheduled safe zone. In an embodiment, the safe zone may be gradually reduced to the scheduled safe zone over a preset time period. As the safe zone is reduced, tiles that are no longer within the safe zone may be destroyed. In an embodiment, in a case in which the game map is configured as a three-dimensional space, the destruction of tiles that are no longer within the safe zone may be implemented as the safe zone tiles falling downward. That is, in the present embodiment, as the safe zone is gradually reduced to the scheduled safe zone, tiles that are no longer within the safe zone may gradually fall downward, starting from the tiles farthest from the safe zone.

The third diagram of FIG. 5 illustrates a new safe zone formed as the safe zone has been reduced to the scheduled safe zone. Referring to the third diagram of FIG. 5, after the safe zone is reduced, tiles that are not included in the safe zone may be considered as unsafe zone tiles.

Although the safe zone and the scheduled safe zone in FIG. 5 are illustrated as being formed in a circular shape, this is merely an example, and they may be designed to be formed or set in any suitable shape and standard. For example, the safe zone or the scheduled safe zone may be elliptical. For example, the safe zone may be designed to be reduced by destroying some of a plurality of safe zone tiles, for example, the outermost tiles or tiles with four or fewer adjacent tiles, without setting a separate scheduled safe zone.

As another example, a scheduled safe zone may be set without determining a reduction center tile. Even in this case, it may be preferable to set the scheduled safe zone to be included in the safe zone.

In an embodiment, time-based tile destruction may be performed repeatedly according to a preset time schedule. For example, there may be a scheduled maximum game duration, and the scheduled maximum game duration may be divided into a plurality of time intervals by any suitable method. The plurality of time intervals may include one or more safe zone reduction time intervals and one or more waiting time intervals. According to various embodiments, the safe zone reduction time interval may be a time interval during which the safe zone is gradually reduced, and the waiting time interval may be a time interval during which the safe zone is maintained without being reduced. The lengths of the one or more safe zone reduction time intervals may be different from each other, or the lengths of the one or more waiting time intervals may be different from each other. The amount of safe zone reduction may differ between the one or more safe zone reduction time intervals.

For example, it may be designed such that a maximum game duration is 30 minutes, a first waiting time interval is 5 minutes, a first safe zone reduction time interval is 8 minutes, a second waiting time interval is 3 minutes, a second safe zone reduction time interval is 6 minutes, a third waiting time interval is 2 minutes, a third safe zone reduction time interval is 4 minutes, and a fourth waiting time interval is 2 minutes.

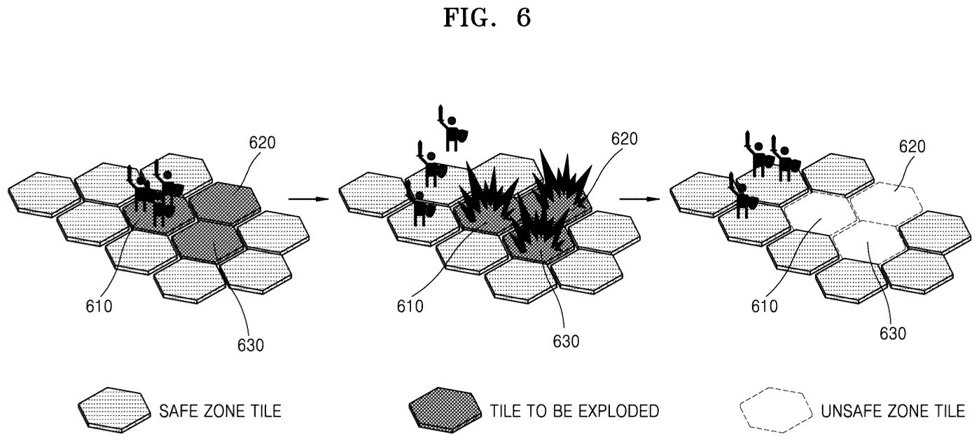

FIG. 6 is a diagram for describing a process in which safe zone tiles are destroyed based on the density of game objects, according to an embodiment of the present disclosure.

Hereinafter, for convenience of description, the destruction of safe zone tiles based on the density of game objects is referred to as density-based tile destruction.

In the present disclosure, density-based tile destruction, in addition to time-based tile destruction, may function as an element that enables a different and unique experience compared to existing battle royale games and provides a new variable to combat between characters.

In an embodiment, a tile that has reached among safe zone tiles a threshold density may be detected. For example, among a plurality of safe zone tiles, a particular tile that includes a threshold number or more of game objects may be detected. In another embodiment, it may be designed such that a particular tile is detected as having reached the threshold density only after maintaining that density for a threshold time period. For example, the threshold time period may be 3 seconds.

Referring to the first diagram of FIG. 6, a third tile 610 among a plurality of safe zone tiles includes three game objects (e.g., user characters) that are engaged in combat, and it may be determined that the third tile 610 has reached the threshold density.

In an embodiment, one or more of the plurality of safe zone tiles may be determined to be destroyed, based on a tile that has reached the threshold density. For example, the tiles to be destroyed may include the tile that has reached the threshold density and a preset number of tiles adjacent to the tile that has reached the threshold density. The number of adjacent tiles included in the tiles to be destroyed may be set to any appropriate number, and any appropriate method may be applied to determine which adjacent tiles to include in the tiles to be destroyed from among the tiles adjacent to the tile that has reached the threshold density. For example, arbitrary two or three, or all of the tiles adjacent to the tile that has reached the threshold density may be included in the tiles to be destroyed. As another example, the tiles to be destroyed may include only the tile that has reached the threshold density, and not include tiles adjacent to the tile that has reached the threshold density.

Referring to the first diagram of FIG. 6, among the plurality of safe zone tiles, the third tile 610 and a fourth tile 620 and a fifth tile 630 that are adjacent to the third tile 610 may be determined as tiles to be destroyed. That is, in the illustrated example, the tiles to be destroyed include the fourth tile 620 and the fifth tile 630, which are two tiles adjacent to the third tile 610 that has reached the threshold density.

In an embodiment, one or more of the tiles to be destroyed may be destroyed after a preset time period has elapsed. For example, the preset time period may be designed to be any appropriate time period, such as 3 seconds or 5 seconds.

In addition, in an embodiment, a graphic effect that distinguishes between tiles to be destroyed and tiles not to be destroyed may be applied for a preset time period. For example, after the tiles to be destroyed is determined, the tiles to be destroyed may be displayed in red for a preset time period before being destroyed.

Referring to the second diagram of FIG. 6, the third tile 610, the fourth tile 620, and the fifth tile 630 included in the tiles to be destroyed are destroyed.

In an embodiment, when the tiles to be destroyed are destroyed, the safe zone tiles corresponding to the tiles to be destroyed may be converted into unsafe zone tiles.

Referring to the third diagram of FIG. 6, the third tile 610, the fourth tile 620, and the fifth tile 630 are converted into unsafe zone tiles after being destroyed.

In an embodiment, unlike the time-based tile destruction described above with reference to FIG. 5, the density-based tile destruction described above with reference to FIG. 6 involves the destruction of safe zone tiles, and thus may generate a knock-back effect on game objects within a preset distance from the destroyed tiles. The knock-back effect may include an effect that inflicts damage on game objects. That is, when a tile is destroyed by density-based tile destruction, an effect of inflicting damage on game objects close to the destroyed tile and pushing away the game objects. In an embodiment, the distance by which a user character is knocked back may vary depending on the user character's remaining health. For example, a user character with lower remaining health may be knocked back a greater distance.

Referring to the second diagram of FIG. 6, as the third tile 610, the fourth tile 620, and the fifth tile 630 are destroyed, three game objects are knocked back to the periphery.

In an embodiment, unlike time-based tile destruction, density-based tile destruction may be designed to be performed independently of the passage of time in the game.

Hereinafter, a process of controlling a jump motion among motions of a user character according to various embodiments of the present disclosure will be described. Various embodiments to be described below may be performed by a device for controlling a motion of a user character, and specifically, may be executed by a processor included in the device for controlling a motion of a user character.

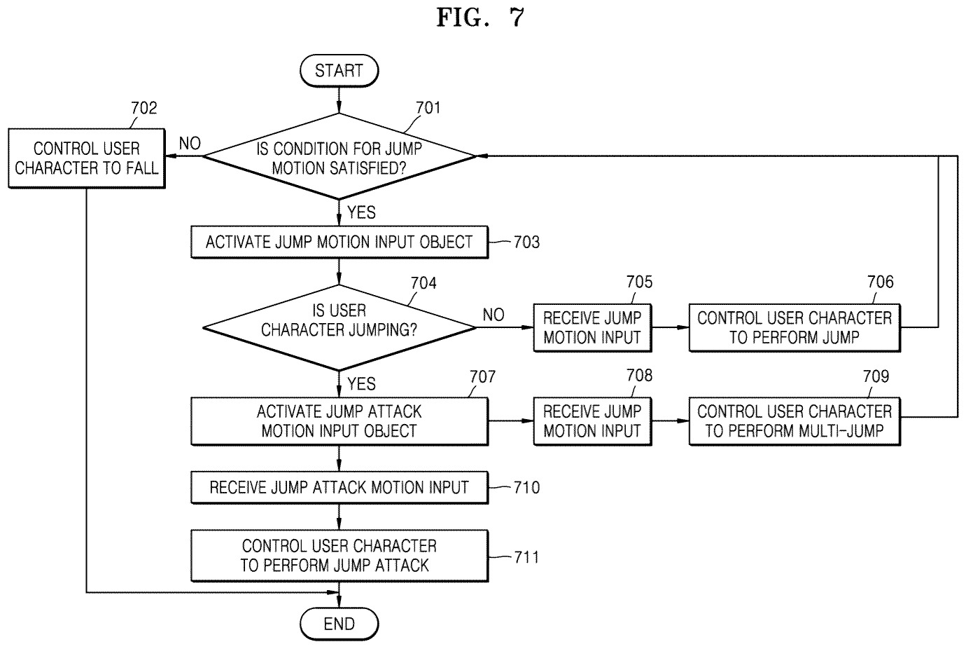

FIG. 7 is a flowchart for describing a process of controlling a motion associated with a jump of a user character, according to an embodiment of the present disclosure.

In an embodiment, the device for controlling a motion of a user character may determine whether a condition for a jump motion of a user character is satisfied (701).

In the present disclosure, the jump motion may be initiated only when a preset condition is satisfied. Restricting the jump motion to only when the preset condition is satisfied may be for the purpose of facilitating the seamless progression of the game and inducing active combat between users.

In an embodiment, the preset condition may include that the user character is airborne. That the user character is airborne may mean that the user character is not standing on a ground surface.

In an embodiment, the preset condition may include that a height value (e.g., a z-coordinate) of the location of the user character is within a preset range or is different from a height value (e.g., a z-coordinate) of the ground surface.

In an embodiment, cases in which the user character is airborne may include cases in which the user character is jumping. The cases in which the user character is in a jumping motion may include cases in which the user character jumps due to a user input, and cases in which the user character jumps due to jump interaction objects.

In an embodiment, the jump interaction objects may include jump interaction objects placed on the ground surface, and jump interaction objects placed on water surfaces.

In an embodiment, the jump interaction objects placed on ground surfaces may refer to objects that are placed on the ground surface and, when the user moves the user character to the jump interaction objects placed on the ground surface, cause the user character to jump in directions preset for the respective jump interaction objects placed on the ground surface. In an embodiment, unlike the jump interaction objects placed on water surfaces, the jump interaction objects placed on the ground surface may be always active. That is, the moment the user character moves to the jump interaction object placed on the ground surface, the user character may be controlled to jump.

In an embodiment, the jump interaction objects placed on water surfaces may refer to objects that are placed on water surfaces and, when the user moves the user character to the jump interaction objects placed on water surfaces, cause the user character to jump in the direction in which the user character is moving or facing. In an embodiment, unlike the jump interaction object placed on the ground surface, the jump interaction objects placed on water surfaces may be activated periodically. That is, the user character may be controlled to jump only when the user character is present on the jump interaction object placed on a water surface and the jump interaction object is active. For example, the jump interaction objects placed on water surfaces may be represented as a water column that explodes and rises at regular intervals. For example, the interval may be 5 seconds, 10 seconds, etc.

In an embodiment, the cases in which the user character is airborne may include cases in which the user character is being knocked back. The cases in which the user character is being knocked back may include cases in which the user character is knocked back due to tile destruction, cases in which the user character is knocked back due to an attack by another user, and the like.

In an embodiment, the cases in which the user character is airborne may include cases in which the user character is in an unsafe zone. For example, when the coordinates of the user character on the plane of the game map (e.g., the x-y plane) are in an unsafe zone, the user character may be considered to be airborne.

In an embodiment, the preset condition may include that the user character is present in an incomplete safe zone, for example, on a water surface. In an embodiment, when the user character is present on a water surface, the user character may escape from the water surface through a jump motion. In an embodiment, when the user character is present on a water surface, the stamina of the user character may be depleted over time.

In an embodiment, the preset condition may include that the stamina of the user character is sufficient for jumping. When the stamina of the user character is not sufficient for jumping, the device for controlling a motion of a user character may determine that the condition for the jump motion of the user character is not satisfied.

In the present disclosure, the stamina of the user character may be consumed to perform a jump. Stamina may be an element for limiting repeated execution of a particular motion among various motions of a user character, and may be included in status information of the user character. In an embodiment, the device controlling the jump motion of the user character may calculate the stamina required for a jump, and when the stamina required for the jump is greater than the stamina of the user character, determine that the stamina of the user character is not sufficient for jumping. When the jump of the user character is triggered, a preset amount of stamina may be deducted from the current stamina of the user character.

In an embodiment, the stamina of the user character may be gradually charged over time when not in use. For example, the stamina of the user character may increase according to a time period during which the user character is located within a safe zone or a time period during which the user character stands on a safe zone tile after landing.

In an embodiment, the preset condition may be that the user character is located on terrain higher than the ground surface. For example, cases in which the user character is located on terrain higher than the ground surface may include cases in which the user character lands on a hill terrain or a building, and the like.

The above-described embodiments regarding the preset condition may be appropriately combined. For example, the preset condition may be that the stamina of the user character is sufficient for jumping and the user character is airborne or in an incomplete safe zone.

In an embodiment, when it is determined that the condition for the jump motion of the user character is not satisfied, the device for controlling a motion of a user character may control the user character to fall (702).

Here, that a character falls may mean that the character decreases in height in the direction of the height axis (e.g., the z-axis) of the game map. When the character falls, depending on the coordinates of the character in the plane (x-y plane), the character may belong to the ‘ground surface’, a ‘water surface’, or an unsafe zone tile.

In an embodiment, when it is determined that the condition for the jump motion of the user character is satisfied, the device for controlling a motion of a user character may activate a jump motion input object (703).

In the present disclosure, the jump motion input object may refer to an object with which the user may interact to input a jump motion. For example, the user may input the jump motion of the user character by selecting the jump motion input object (e.g., a particular key input, click, or touch).

In an embodiment, the jump motion input object may be activated in place of another motion input object. That is, as the jump motion input object is activated, another motion input object may be deactivated. For example, the other motion input object may be a rapid movement motion input object.

According to the present embodiment, the user may input the jump motion only when the condition for the jump motion of the user character is satisfied.

In an embodiment, the device for controlling a motion of a user character may determine whether the user character is jumping (704).

In the present embodiment, determining whether the user character is jumping (704) may have the same meaning as determining whether a condition for a jump attack, which will be described below, is satisfied. In an embodiment, when the user character is airborne, the jump of the user character may be possible, and the cases in which the user character is airborne may include cases in which the user character is in the jump motion. When the user character is in the jump motion, the user character may perform a jump attack.

In an embodiment, when the device for controlling a motion of a user character determines that the user character is not jumping, and receives a jump motion input (705), the device may control the user character to jump (706).

In an embodiment, based on receiving a user input for the jump motion input object, the device for controlling a motion of a user character may control the user character to jump.

The present embodiment may be distinguished from a case in which, when the character is jumping and a jump motion input is received, the character is controlled to perform a multi-jump, as will be described below.

In an embodiment, a jump direction of the user character may be controlled according to a character direction input by the user.

In an embodiment, when it is determined that the user character is jumping, the device for controlling a motion of a user character may activate a jump attack motion input object (707).

In the present disclosure, the jump attack motion input object may refer to an object with which the user may interact to input a jump attack motion. For example, the user may input the jump attack motion of the user character by selecting the jump attack motion input object (e.g., a particular key input, click, or touch).

According to the present embodiment, the user may input the jump motion only when a condition for the jump attack motion of the user character, that is, that the user character is jumping, is satisfied.

In an embodiment, when the jump attack motion input object is activated (707) and a jump motion input is received (708), the device for controlling a motion of a user character may control the user character to perform a multi-jump (709).

In the present disclosure, the multi-jump refers to consecutive jump motions, and through the multi-jump, the user character may perform an additional jump after the initial jump and before landing on the ground surface. As with a normal jump motion, the stamina of the user character may be consumed to perform the multi-jump.

In an embodiment, the stamina required for the multi-jump may be greater than the stamina required for the normal jump.

In an embodiment, the stamina required for a multi-jump may vary depending on the number of multi-jumps. In an embodiment, as the number of multi-jumps increases, the stamina required for another multi-jump may also increase. For example, the stamina required for performing a (N+2)-th multi-jump immediately after performing N+1 consecutive multi-jumps, that is, without landing on a ground surface (e.g., a safe zone tile), may be greater than the stamina required for performing the (N+1)-th multi-jump immediately after performing N consecutive multi-jumps, that is, without landing on the ground surface (e.g., a safe zone tile).

In an embodiment, the heights of jumps may be different from each other depending on the number of multi-jumps. For example, as the number of multi-jumps increases, the heights of the jumps may gradually decrease. Here, the height of a jump may refer to the difference between the height at the moment the jump is triggered and the height of the highest point in the corresponding jump section.

In an embodiment, when the jump attack motion input object is activated (707) and a jump attack motion input is received (710), the device for controlling a motion of a user character may control the user character to perform a jump attack (711).

In the present disclosure, the jump attack may be a special attack that may be used only when the user character is jumping. In an embodiment, the jump attack may exhibit different in-game effects depending on the type of the user character. In an embodiment, similar to a normal attack to be described below, the jump attack may involve automatic targeting.

In an embodiment, the user character may fall while performing a jump attack. That is, after the user character performs a jump attack, the user character may belong to the ‘ground surface’, a ‘water surface’, or an unsafe zone tile depending on the coordinates of the user character in the plane (x-y plane). In an embodiment, when the jump attack involves automatic targeting, the user character may fall at the location of another user character that is the target of the attack.

In an embodiment, when a preset condition is not satisfied, the jump attack may not be performed even when the user character is jumping. That is, when the preset condition is not satisfied, the jump attack motion input object may be deactivated even when the user character is jumping.

For example, the preset condition may be that the height of the character is greater than or equal to a threshold value. That is, when the height of the character is not sufficiently high, the jump attack motion input object may be deactivated even when the user character is jumping. The threshold value for the height of the character at which the jump attack is possible may be set to any appropriate value.

In addition, when the user character is airborne, an object may be displayed to visually indicate the location corresponding to the coordinates of the user character in the plane (x-y plane). The object that visually indicates the location corresponding to the coordinates of the character in the plane may have a suitable form that allows the user to effectively identify the location of the user character, and may be configured, for example, as a grid. In addition, for example, the object that visually indicates the location corresponding to the coordinates of the character in the plane may be displayed at a location corresponding to a z-coordinate different from the z-coordinate where the user character is located.

In an embodiment, the object that visually indicates the location corresponding to the coordinates of the user character in the plane may be displayed only when the coordinates of the user character in the plane belong to a preset tile. For example, the preset tile may be an incomplete safe zone tile, for example, a tile including a water surface, or an unsafe zone tile.

Meanwhile, the process order in FIG. 7 is provided as an example and may be changed to any appropriate order, and some operations may be omitted. For example, the device for controlling a motion of a user character may first determine whether the user character is jumping, and then activate the jump motion input object based on whether the condition for the jump motion is satisfied.

Hereinafter, a process of controlling a combat motion of a user character according to various embodiments of the present disclosure will be described. Various embodiments to be described below may be performed by a device for controlling a motion of a user character, and specifically, may be executed by a processor included in the device for controlling a motion of a user character.

In the present disclosure, a user character may be controlled to perform various combat motions. Combat motions of user characters may have different in-game effects depending on the type of character. For example, some types of characters may perform a basic attack through a close-range attack, while other types of characters may perform a basic attack through a long-range attack.

In an embodiment, the user character may be controlled to perform a basic attack. In the present disclosure, the basic attack may refer to the most fundamental attack motion among the combat motions of the user character. The user may input an attack motion by interacting with an attack motion input object. In response to receiving an attack motion input, the device for controlling a motion of a user character may control the user character to perform the basic attack.

In an embodiment, the user character may be controlled to perform a consecutive attack. In the present disclosure, the consecutive attack may refer to a motion in which the user character may consecutively strike another user character during a combat motion. The user may input a consecutive attack motion by interacting with a consecutive attack motion input object. In response to receiving a consecutive attack motion input, the device for controlling a motion of a user character may control the user character to perform a consecutive attack. In an embodiment, the consecutive attack motion input object may be activated after the user character performs the basic attack. The consecutive attack will be described in detail below.

In an embodiment, the user character may be controlled to perform an evasion. In the present disclosure, the evasion may refer to a motion in which the user character may evade an attack from another user character during a combat motion. The user may input an evasion motion by interacting with an evasion motion input object. In response to receiving an evasion motion input, the device for controlling a motion of a user character may control the user character to evade an attack. In an embodiment, when the user character performs an attack motion within a threshold time period after performing the evasion motion, the user character may perform an evasion attack. After the user character performs the evasion motion, an evasion attack motion input object may be activated for a threshold time period, and when the user interacts with the activated evasion attack motion input object, an evasion attack motion may be performed.

In an embodiment, the user character may be controlled to perform a rapid movement. In the present disclosure, the rapid movement may refer to a motion that allows the user character to move faster than a normal movement. The user may input a rapid movement motion by interacting with a rapid movement input object. In response to receiving a rapid movement motion input, the device for controlling a motion of a user character may control the user character to perform the rapid movement. In an embodiment, the stamina of the user character may be consumed to perform a rapid movement motion.

In an embodiment, the user character may be controlled to perform a jump attack. In the present disclosure, the jump attack may refer to a motion in which the user character may strike another user character while jumping during a combat motion. The user may input a jump attack motion by interacting with a jump attack motion input object. In response to receiving a jump attack motion input, the device for controlling a motion of a user character may control the user character to perform the jump attack. In an embodiment, the jump attack motion input object may be activated only when the user character is jumping. In addition, activating the jump attack motion input object may include deactivating an attack motion input object. Alternatively, an attack motion input object may be converted into a jump attack motion input object. For example, a jump attack motion input object may be located at the same position as an attack motion input object on an interface, but may have a different shape.

In an embodiment, the user character may be controlled to use an ultimate skill. In the present disclosure, the ultimate skill may refer to the most powerful attack motion among the combat motions of the user character. The user may input an ultimate skill motion by interacting with an ultimate skill motion input object. In response to receiving an ultimate skill motion input, the device for controlling a motion of a user character may control the user character to use the ultimate skill. In an embodiment, the ultimate skill motion input object may be activated only when an ultimate skill gauge is greater than or equal to a predetermined value. For example, the ultimate skill gauge may be charged when the user character inflicts damage on another user character or receives damage from another user, or gradually over time. In an embodiment, when the user inputs the ultimate skill motion through the ultimate skill motion input object, the ultimate skill may not be used immediately to inflict damage on another user character, but a preliminary motion may be performed before using the ultimate skill. In the present disclosure, the preliminary motion before using the ultimate skill may serve as an element that may create tension or attract the attention of users in the game. While the user character is performing the preliminary motion before using the ultimate skill, the user character may be in a state in which it does not take damage from other user characters, a so-called ‘invincible’ state.

In an embodiment, various combat motions may involve automatic targeting. In the present disclosure, automatic targeting may mean that even when the user does not specify a target or direction of a particular motion of the user character, an appropriate target or direction around the user character to perform the motion is automatically set. For example, when automatic targeting is involved when the user interacts with an attack motion input object while the user character is not facing directly a first user character, an attack may be made toward the first user character, rather than in the direction the user character is facing. In an embodiment, the first user character may be the nearest enemy. Any appropriate method may be applied to automatic targeting. In an embodiment, the jump attack may also involve automatic targeting. For example, when the user character is a close-combat character and performs the jump attack, the user character may quickly move to another automatically targeted user character to inflict damage.

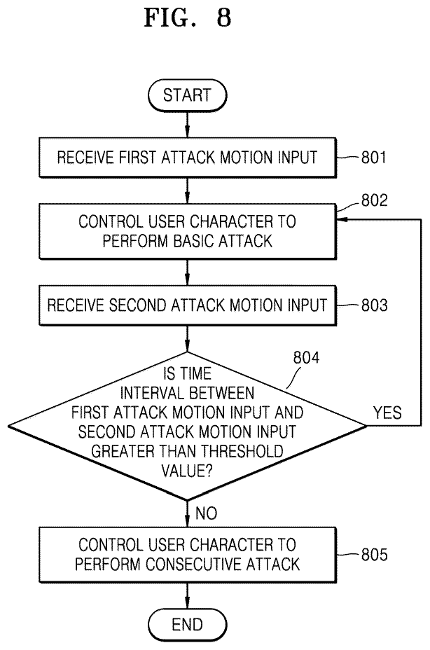

FIG. 8 is a flowchart for describing a process of controlling a consecutive attack motion of a user character, according to an embodiment of the present disclosure.

As described above, the consecutive attack may refer to a motion in which a user character may consecutively strike another user character during a combat motion.

In an embodiment, the device for controlling a motion of a user character may receive a first attack motion input (801).

In an embodiment, the user may input a first attack motion by interacting with an attack motion input object.

In an embodiment, when a first attack motion input is received (801), the device for controlling a motion of a user character may control the user character to perform the basic attack (802).

In an embodiment, the device for controlling a motion of a user character may receive a second attack motion input (803).

In an embodiment, the user may input a second attack motion by interacting with an attack motion input object or a consecutive attack motion input object.

In an embodiment, the device for controlling a motion of a user character may determine whether a time interval between the first attack motion input and the second attack motion input is greater than a threshold value (804).

In an embodiment, when the time interval between the first attack motion input and the second attack motion input is greater than the threshold value, the device for controlling a motion of a user character may control the user character to perform the basic attack (802).

On the contrary, in an embodiment, when the time interval between the first attack motion input and the second attack motion input is not greater than the threshold value, the device for controlling a motion of a user character may control the user character to perform the consecutive attack (805). That is, the device for controlling a motion of a user character may determine whether to regard the second attack motion input as a basic attack motion input or a consecutive attack motion input, based on the time interval between the first attack motion input and the second attack motion input.

In an embodiment, the maximum number of possible consecutive attacks may vary depending on the type of character. For example, in a case in which the user character is a character of a first type, a total of three consecutive attacks may be possible, and in a case in which the user character is a character of a second type, a total of four consecutive attacks may be possible. For example, in a case in which the user character is capable of a total of three consecutive attacks, the embodiment illustrated in FIG. 8 may be analogically applied between the second attack motion input and a third attack motion input.

In an embodiment, when the last of consecutive attacks by the user character hits another user, the other user character may be knocked back. For example, when the user character is capable of a total of three consecutive attacks and the third consecutive attack hits another user character, the other user character may be knocked back.

In an embodiment, when the last of the consecutive attacks hits a user character and thus the user character is knocked back, the distance by which the user character is knocked back may vary depending on the remaining health of the user character. For example, a user character having less remaining health may be knocked back by a greater distance.

Meanwhile, the process of controlling a consecutive attack motion illustrated in FIG. 8 may be implemented by changing or modifying a motion input object.

For example, in FIG. 8, the controlling of the user character to perform the basic attack (802) may include activating a consecutive attack motion input object. That is, when the first attack motion input is received (801), the device for controlling a motion of a user character may activate a consecutive attack motion input object.

In an embodiment, the activating of the consecutive attack motion input object may include deactivating an attack motion input object. That is, the attack motion input object may be deactivated and the consecutive attack motion input object may be activated.

In another embodiment, the attack motion input object may be converted into a consecutive attack motion input object. For example, a consecutive attack motion input object may be located at the same position as an attack motion input object on an interface, but may have a different shape.

When a time period according to the threshold value in FIG. 8 elapses, the consecutive attack motion input object may be deactivated. That is, when the time period according to the threshold value elapses, it may be impossible for the user to input a consecutive attack motion.

In an embodiment, the deactivating of the consecutive attack motion input object when the time period according to the threshold value elapses may include activating the attack motion input object.

In another embodiment, when the time period according to the threshold value elapses, the consecutive attack motion input object may be converted back into the attack motion input object.

Hereinafter, a case in which the user character is eliminated from the game and the user may no longer participate in the game will be described.

In an embodiment, when the height of the user character in the direction of the height axis (e.g., the z-axis) of the game map is less than or equal to a threshold value, the user character may be eliminated from the game. For example, when the user character falls on a tile that does not include a ground surface, causing the user character to fall, the user character may be eliminated from the game.

In an embodiment, when the stamina of the user character is completely depleted and the user character is located in an incomplete safe zone, the user character may be eliminated from the game. For example, when the user character has been continuously located on a water surface, the user character may be eliminated from the game.

In an embodiment, when the user character is attacked or knocked back a preset number of times or more in a groggy state, the user character may be eliminated from the game. In the present disclosure, the groggy state may refer to a state that is triggered when the health of the user character is completely depleted by an attack from another user character. While in the groggy state, the user character may be unable to perform any motion. The groggy state may be maintained for a preset time period, and when the preset time period elapses, the user character may recover a small amount of health and then resume performing motions according to a user input.

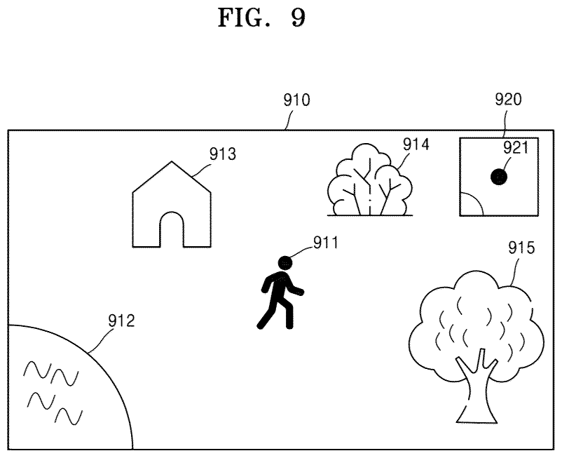

FIG. 9 is a diagram for describing an interface provided to a user, according to an embodiment of the present disclosure.

Referring to FIG. 9, the device for controlling a motion of a user character may provide a first interface 910 that displays a user character 911, a game map, and at least one in-game object from a predetermined viewpoint.

The game map according to an embodiment may be implemented based on map information included in game data, and may be composed of one or more tiles for implementing a safe zone and an unsafe zone.

In the present disclosure, the game map may be generated corresponding to the above-described world map or magnified world map, but may be composed of map elements implemented with a resolution and/or level of detail different from those in the world map and the magnified world map.

In the present disclosure, an in-game object refers to an object implemented through an image on a game map. For example, in-game objects may include objects on a game map that are independently identified. For example, in-game objects may include map elements, structures, buildings, and/or geographic features.

For example, as illustrated in FIG. 9, the in-game objects may include a water surface 912, a house 913, a bush 914, and/or a tree 915 that are visually expressed on the game map. As another example, although not illustrated in FIG. 9, the in-game objects may include items, item boxes, statues, pillars, and/or jump interaction objects.

The device for controlling a motion of a user character may provide a first interface that displays various types of in-game objects, thereby providing a game experience in various visual environments and various plays using in-game objects.

In addition, in the present disclosure, the device for controlling a motion of a user character may further provide a second interface 920 that displays a mini-map corresponding to the game map and a first character icon 921 on the mini-map corresponding to the user character 911.

The mini-map according to an embodiment may include a map that is a simplified representation of the game map. For example, the mini-map may include a map implemented with a relatively lower resolution and/or level of detail compared to the game map.

The second interface 920 according to an embodiment may not display in-game objects. The second interface 920 according to another embodiment may display only objects having an importance level higher than or equal to a preset level in terms of gameplay importance among the in-game objects.

For example, the device for controlling a motion of a user character may provide the second interface 920 that displays, on the mini-map, items among the in-game objects. As another example, the device for controlling a motion of a user character may provide the second interface 920 that displays, on the mini-map, only items having a grade attribute higher than or equal to a certain grade among items.

In addition, the first character icon 921 corresponding to the user character 911 may be displayed on the second interface 920.

In an embodiment, information such as character information, user information, and/or team information may be displayed in a simple and intuitive manner on character icons including the first character icon 921. For example, the character information may be expressed as a portrait of the corresponding character, the user information may be expressed as a nickname of the user playing the corresponding character, and the team information may be expressed as a border color of the icon.

In an embodiment, appropriate visual effects associated with various embodiments described above with reference to FIGS. 1 to 8 may be expressed on the first interface 910 or the second interface 920.

For example, the device for controlling a motion of a user character may provide the first interface 910 and/or the second interface 920 in which a visual effect expressing a motion of the user character 911, such as a movement, an attack, or a jump, is expressed.

For example, in relation to time-based tile destruction or density-based tile destruction, the device for controlling a motion of a user character may provide the first interface 910 and/or the second interface 920 in which a visual effect indicating an impending destruction is expressed.

As another example, in relation to time-based tile destruction, the device for controlling a motion of a user character may provide the first interface 910 and/or the second interface 920 in which a visual effect indicating a scheduled safe zone or a safe zone is expressed.

As another example, in relation to time-based tile destruction, the device for controlling a motion of a user character may provide the first interface 910 and/or the second interface 920 in which a visual effect of a ground surface falling is expressed.

As another example, in relation to density-based tile destruction, the device for controlling a motion of a user character may provide the first interface 910 and/or the second interface 920 in which a visual effect of a tile being destroyed is expressed.

As another example, when a game object is knocked back due to density-based tile destruction, the device for controlling a motion of a user character may provide the first interface 910 and/or the second interface 920 in which a visual effect of damage being applied is expressed.

In addition, an appropriate visual effect may be expressed on the first interface 910 or the second interface 920 to provide interest in the game.

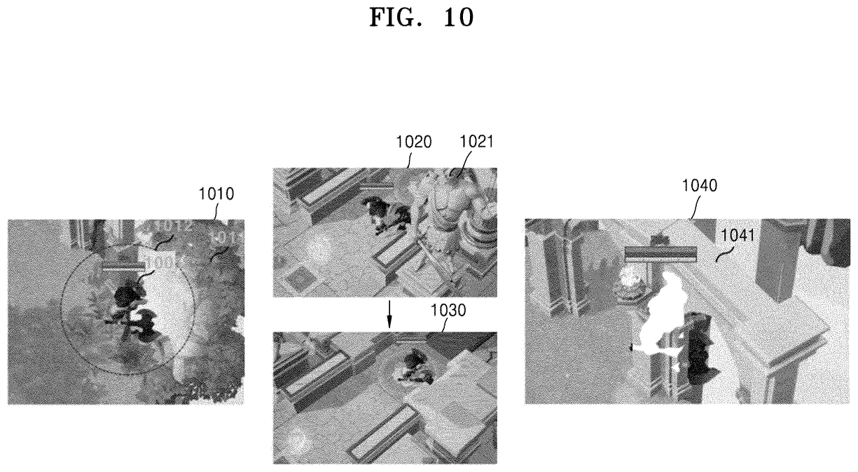

FIG. 10 is a diagram for describing a display effect corresponding to attribute information of an in-game object, according to an embodiment of the present disclosure. Scenes 1010, 1020, 1030, and 1040 illustrated in FIG. 10 may be understood as examples of the first interface 910 illustrated in FIG. 9, and a user character 1001 illustrated in FIG. 10 may be understood as an example of the user character 911 illustrated in FIG. 9.

Referring to FIG. 10, the device for controlling a motion of a user character may set attribute information about each in-game object. Here, when the user character 1001 is obscured by an in-game object, the device for controlling a motion of a user character may provide the first interface 910 that displays the user character 1001 by using a display effect corresponding to the attribute information.

In an embodiment, the device for controlling a motion of a user character may set attribute information about each in-game object based on previously input game data. For example, the previously input game data may be implemented in the form of a mapping table in which any one of first to third attributes is mapped to each in-game object. The device for controlling a motion of a user character may set attribute information about each in-game object according to the mapping table.

In another embodiment, the device for controlling a motion of a user character may set the attribute information based on image characteristics of the in-game object. For example, when the size of the object is greater than or equal to a predetermined size, and the amount of pattern change per area of the object is greater than or equal to a predetermined threshold, like a tree 1011, the attribute information may be set as the first attribute. As another example, when the size of the object is less than the predetermined size and the amount of pattern change per area of the object is greater than or equal to the predetermined threshold, like a statue 1021, the attribute information may be set as the second attribute. As another example, when the amount of pattern change per area of the object is less than the predetermined threshold, like a pillar 1041, the attribute information may be set as the third attribute.

In the present disclosure, the amount of pattern change per area is an index indicating the visual complexity of an object, and the amount of pattern change per area according to an embodiment may be calculated based on an image gradient for an interface on which the object is displayed.

According to an embodiment, whether the amount of pattern change per area of the object is greater than or equal to the predetermined threshold may be determined based on the amount of change in chroma, lightness, and luminance with the object that appears per total area of the object. For example, as the amount of change in chroma, lightness, or luminance per area of the object increases, the amount of pattern change per area may increase, and the amount of change in chroma, lightness, or luminance per area of the object decreases, the amount of pattern change per area may decrease.

A case in which the user character 1001 is obscured by the tree 1011 that is an in-game object will be described with reference to the first scene 1010.

The device for controlling a motion of a user character may provide the first interface 910 that displays the user character 1001 by using an effect of not displaying a part of the in-game object, as a first display effect corresponding to in-game objects having the first attribute.

For example, when the user character 1001 is obscured by an object whose size is greater than or equal to a predetermined size and whose pattern is larger than or equal to a predetermined threshold, for example, the tree 1011, the device for controlling a motion of a user character may determine a display restriction range 1012 for in-game objects around the user character 1001, and provide the first interface 910 that displays the user character 1001 by displaying only images outside the display restriction range 1012 for the in-game objects.

In addition, for a natural visual effect, the in-game objects around the display restriction range 1012 may be displayed to be gradually visible in an outward direction of the display restriction range 1012.

A case in which the user character 1001 is obscured by the statue 1021 that is an in-game object will be described with reference to the second scene 1020 and the third scene 1030. The second scene 1020 is a scene before the user character 1001 is obscured by the statue 1021, and the third scene 1030 is a scene after the user character 1001 is obscured by the statue 1021.

The device for controlling a motion of a user character may provide the first interface 910 that displays the user character 1001 by using an effect of not displaying the entirety of in-game objects, as a second display effect corresponding to in-game objects having the second attribute.

For example, when the user character 1001 is obscured by an object whose size is less than the predetermined size and whose pattern is larger than or equal to the predetermined threshold, for example, the statue 1021, the device for controlling a motion of a user character may provide the first interface 910 that displays the user character 1001 by not displaying the entirety of an in-game object.

A case in which the user character 1001 is obscured by the pillar 1041 that is an in-game object will be described with reference to the fourth scene 1040.

The device for controlling a motion of a user character may provide the first interface 910 that displays the user character 1001 by using an effect of displaying a monochromatic character silhouette with respect to a range where the in-game object and the user character 1001 overlap each other, as a third display effect corresponding to in-game objects having the third attribute.

For example, when the user character 1001 is obscured by an object whose pattern is less than the predetermined threshold, for example, the pillar 1041, the device for controlling a motion of a user character may determine an area where the user character 1001 and the in-game object overlap each other, and provide the first interface 910 that displays the user character 1001 by displaying the overlapping area as a monochromatic character silhouette.

The device for controlling a motion of a user character may display a character obscured by an in-game object with a predetermined display effect based on attribute information of the in-game object, thereby solving the problem of character obscuration that occurs in an interface based on a three-dimensional image. In addition, by providing an appropriate display effect for each object, it is possible to minimize the degree to which the immersion of the game is disrupted, while displaying the character.

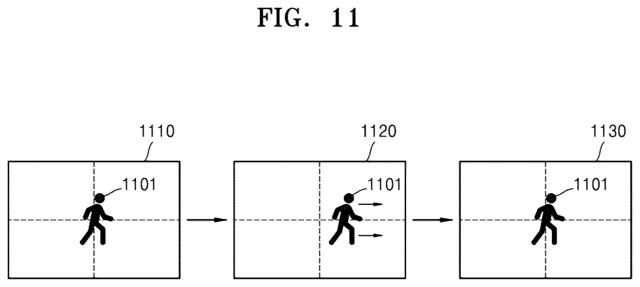

FIG. 11 is a diagram for describing a predetermined viewpoint according to an embodiment of the present disclosure. Scenes 1110, 1120, and 1130 illustrated in FIG. 11 may correspond to the first interface 910 illustrated in FIG. 9, and a user character 1101 illustrated in FIG. 11 may correspond to the user character 911 illustrated in FIG. 9.

In the present disclosure, the predetermined viewpoint may include a third-person viewpoint. In an embodiment, the predetermined viewpoint may include any one of a top view looking down vertically, a quarter view looking down at an angle other than vertical, a shoulder view looking at a character from the rear of the character, and a side view looking at the side of the character. A battle royale game in which a plurality of users participate may be preferably based on a top view or a quarter view, and in particular, when based on a quarter view, three-dimensional representations of various objects and visual effects may be more effectively provided.

Referring to FIG. 11, the predetermined viewpoint according to an embodiment may include a third-person viewpoint in which, when the user character 1101 is not moving, the user character 1101 is located at the center of the first interface 910, and when the user character 1101 is moving in one direction, the viewpoint moves in one direction with a predetermined time interval from the movement of the user character 1101.

The first scene 1110, the second scene 1120, and the third scene 1130 illustrated in FIG. 11 represent an initial stationary state scene, a scene in which the user character 1101 is moving in one direction, and a final stationary state scene, respectively.

The predetermined viewpoint according to an embodiment may include a third-person viewpoint in which the direction of view is fixed and the capture range is dynamic. Here, the capture range may be determined according to zoom in, zoom out, and parallel movement of the viewpoint.

In an embodiment, when the user character 1101 is moving in one direction, the predetermined viewpoint may move in one direction with a predetermined time interval from the movement of the user character 1101. That is, in the second scene 1120, the viewpoint (or center point) of the first interface 910 may be the same as the viewpoint (or center point) of the first interface 910 in the first scene 1110 for a predetermined time period despite the movement of the user character 1101. Accordingly, the second scene 1120 may be understood as a scene in which the center point of the first interface 910 follows the user character 1101 due to the predetermined time interval.

In an embodiment, in the first scene 1110 and the third scene 1130 in which the user character 1101 is not moving, the user character 1101 is displayed to be located at the center of the first interface 910, and when the user character 1101 is moving in one direction, the user character 1101 is displayed to be located inside the first interface 910 and to be biased in the direction in which the user character 1101 is moving, compared to the center of the first interface 910.

The device for controlling a motion of a user character may maximize the dynamics and immersion of a scene by providing the first interface 910 from a third-person viewpoint that moves following the user character 1101 with a predetermined time interval. However, because a directional confusion may occur according to the predetermined time interval, the predetermined time interval may be set to several milliseconds (ms) to several hundred milliseconds. However, the present disclosure is not limited thereto.

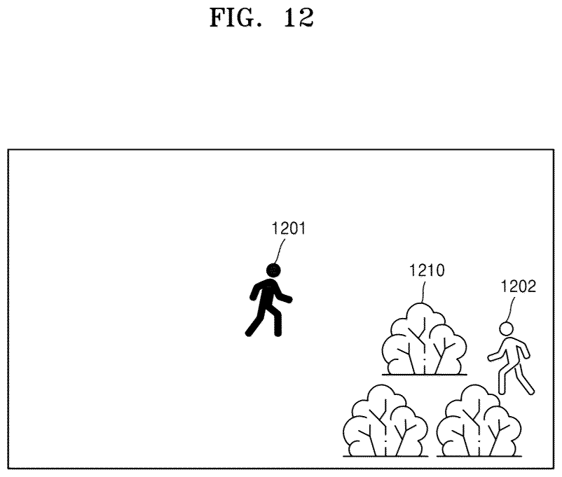

FIG. 12 is a diagram for describing a first interface when another character that is not in an ally state with a user character is located inside a cloaking object, according to an embodiment of the present disclosure. A user character 1201 illustrated in FIG. 12 may correspond to the user character 911 illustrated in FIG. 9.

Referring to FIG. 12, in-game objects according to an embodiment may include character cloaking objects 1210. In a battle royale game, hiding one's own character and identifying the location of other characters are important elements of the game, and in the present disclosure, the cloaking objects 1210 may include in-game objects capable of hiding the location of a character. For example, cloaking objects may include the bush 914 illustrated in FIG. 9, but are not limited thereto.

In an embodiment, the device for controlling a motion of a user character may further display another character 1202 that is not in an ally state with the user character 1201, based on the location of the other character 1202 and a predetermined viewpoint. In an embodiment, the ally state may be applied to another user who is in the same team as the user character in the game. That is, the other character 1202 that is not in the ally state may refer to an enemy in the game, and may refer to a character that is in a different team from the user.

The predetermined viewpoint according to an embodiment may have the capture range described above with reference to FIG. 11, and when the other character 1202 is located within the capture range, the device for controlling a motion of a user character may provide the first interface 910 that further displays the other character 1202.

In addition, in an embodiment, when the user character 1201 is located outside the cloaking objects 1210 (or in an area that does not overlap the cloaking objects) and the other character 1202 is located inside the cloaking objects 1210 (or in an area that overlaps the cloaking objects), the device for controlling a motion of a user character may provide the first interface 910 that does not display the other character 1202. That is, according to the predetermined viewpoint, when the user character 1201 is located outside the cloaking objects and the other character 1202 is located inside the cloaking objects 1210, the other character 1202 is not displayed on the first interface 910 even though the other character 1202 is located inside the capture range.

Accordingly, users are able to hide the location of their characters by using the cloaking objects 1210, and thus, strategic gameplay through the cloaking objects 1210 is required.

In another embodiment, when both the user character 1201 and the other character 1202 are located inside the cloaking objects 1210, the device for controlling a motion of a user character may provide the first interface 910 that displays the other character 1202 based on the distance between the user character 1201 and the other character 1202.

For example, when both the user character 1201 and the other character 1202 are located inside the cloaking objects 1210, and the distance between the user character 1201 and the other character 1202 is less than a predetermined distance, the device for controlling a motion of a user character may provide the first interface 910 that displays the other character 1202. On the contrary, when both the user character 1201 and the other character 1202 are located inside the cloaking objects 1210 but the distance between the user character 1201 and the other character 1202 is greater than the predetermined distance, the other character 1202 may not be displayed on the first interface 910.

In an embodiment, when both the user character 1201 and the other character 1202 are located inside the cloaking objects 1210 but a first cloaking object where the user character 1201 is located and a second cloaking object where the other character 1202 is located are not connected to each other, even though the distance between the user character 1201 and another character 1202 is less than the predetermined distance, the other character 1202 may not be displayed on the first interface 910.

Through this, the device for controlling a motion of a user character may improve the interest of gameplay by requiring strategic gameplay using the cloaking objects 1210, and may also provide an interface that improves realism and immersion by using realistic geographic features.

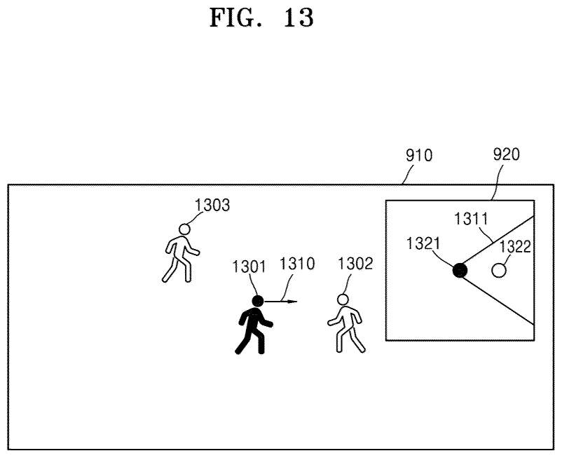

FIG. 13 is a diagram for describing a second interface that displays a character icon corresponding to another character that is not in an ally state with a user character, according to an embodiment of the present disclosure. A user character 1301 illustrated in FIG. 13 may correspond to the user character 911 illustrated in FIG. 9, and a first character icon 1321 illustrated in FIG. 13 may correspond to the first character icon 921 illustrated in FIG. 9. In addition, other characters 1302 and 1303 that are not in an ally state with the user character illustrated in FIG. 13 may correspond to the other character 1202 illustrated in FIG. 12.

As described above with reference to FIG. 9, the device for controlling a motion of a user character may provide the second interface 920 that displays the mini-map corresponding to the game map and the first character icon 1321 on the mini-map corresponding to the user character 1301.

Hereinafter, the second interface will be described with reference to FIG. 13, but for convenience, the user character 1301 will be referred to as a first character, the other character 1302 on the right side of the user character will be referred to as a second character, and the other character 1303 on the upper left side of the user character will be referred to as a third character.

In an embodiment, the device for controlling a motion of a user character may provide the second interface 920 that displays a second character icon 1302 corresponding to the second character 1302, which is not in an ally state with the first character 1301, based on the distance between the first character 1301 and the second character 1302, and a direction 1310 in which the first character 1301 is facing.

That is, only character icons for other characters that satisfy a predetermined condition based on the direction 1310 in which the first character 1301 is facing, and the distance from the first character 1301 may be displayed on the second interface 920.

As a specific example, the predetermined condition may include a condition that the other character is included in a predetermined field-of-view range 1311 according to the direction 1310 in which the first character 1301 is facing, and that the distance between the other character and the first character 1301 is less than a predetermined distance.

In an embodiment, the distance between the first character 1301 and the second character 1302 may be equal to the distance between the first character 1301 and the third character 1303. In this case, when the second character 1302 is included in the predetermined field-of-view range 1311 according to the direction 1310 in which the first character 1301 is facing, the second character icon 1322 corresponding to the second character 1302 may be displayed on the second interface 920. On the contrary, when the third character 1303 is not included in the predetermined field-of-view range 1311 according to the direction 1310 in which the first character 1301 is facing, a character icon corresponding to the third character 1303 may not be displayed on the second interface 920.

According to an embodiment, even when another character is displayed on the first interface 910, a character icon of the other character may not be displayed on the second interface 920, and even when a character icon of another character is displayed on the second interface 920, the other character may not be displayed on the first interface 910.

Through this, the device for controlling a motion of a user character may provide a more tense gameplay experience by requiring a strategic change of the direction of the user character 1301 and comprehensive monitoring of the first interface and the second interface.

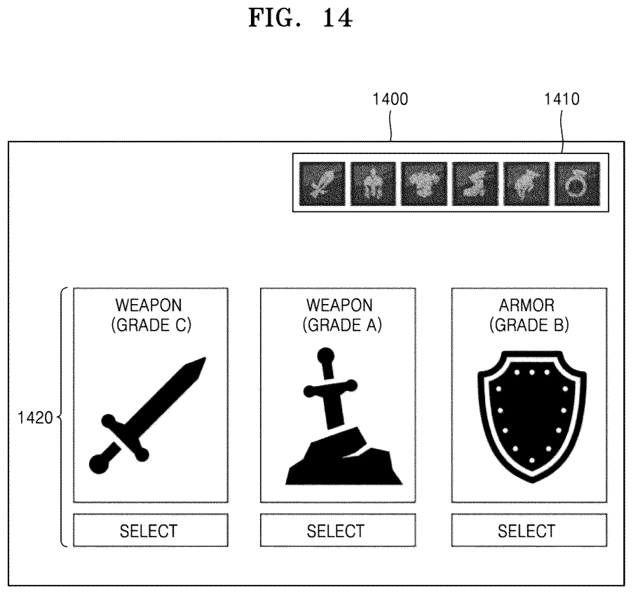

FIG. 14 is a diagram for describing a process of applying an item to a user character, according to an embodiment of the present disclosure.

Items of the present disclosure may include consumable items and wearable items. Here, the consumable items refer to items that may be used during gameplay when obtained, and may be obtained and possessed up to a number designated for each type. An effect of a consumable item according to an embodiment may include any one of health recovery, shield generation, stamina recovery, application of a cloaking state, special attack effect, cloaking detection, teleportation, summoning a jump interaction object, transformation into an in-game object, and transformation into another character, but is not limited thereto.

Referring to FIG. 14, the wearable items refer to items that may be worn individually for each slot 1410, and may include items that are forced to be worn when obtained and cannot be obtained unless worn. The slot 1410 according to an embodiment may have a slot attribute classified by a wearing part, and the slot attribute may be expressed as weapon, helmet, armor, boots, gloves, accessory, or the like, but is not limited thereto.

The wearable items according to an embodiment may have effects that are applied when worn. Here, the effects may include effects on stats of the character, such as maximum health or maximum stamina. For example, a particular helmet item may have a unique effect of increasing the maximum health of the character wearing the item by 15%. Here, the amount of increased health may vary for characters that differ from each other in maximum health.

In addition, a wearable item according to an embodiment may have a grade attribute, and the grade may be expressed as a grade 1 to 5, or Normal, Rare, Epic, Legendary, Mythic, or the like.

In an embodiment, in-game objects may include items and item boxes, and the item boxes may include normal item boxes that do not provide a separate visual effect, and special item boxes that provide visual effects according to the number of obtainable items, slot attributes, and/or grade attributes.

When a user character approaches an item box and stays within a predetermined range for a predetermined time period, when an interaction input for the item box is received, or when the user character performs an attack on the item box, the device for controlling a motion of a user character may cause the item box to drop an item onto a peripheral area.

In addition, the device for controlling a motion of a user character may provide a notification to all users playing the game, before an item having a particular grade attribute is dropped. For example, when a Mythic-grade item is to be dropped, the device for controlling a motion of a user character may provide a notification to all users playing the game, by using the first interface, the second interface, or a visual or auditory means.

Meanwhile, the game in the present disclosure may include a plurality of unit games. For example, when one game is matched, the matched user groups may proceed with a preset number of unit games, and may finally win or lose based on results of the unit games.

For example, when a two-player team combat game is matched, a team whose all team members are eliminated first in each unit game may be unable to participate from the next unit game, and a team that is not eliminated in the last unit game may win the final victory.

As another example, when a one-on-one combat game is matched, a user who wins a preset number of times may win the final victory.

In the present disclosure, the device for controlling a motion of a user character may apply a first item to a user character based on the distance between the user character and the item within a first unit game. In addition, the device for controlling a motion of a user character may apply a second item to a user character based on a result of the first unit game and an item selection input from each user. Here, the second item may be applied to the second unit game.

The first item according to an embodiment may include a first wearable item, and when the distance between the location of the user character on the game map and the location of the first wearable item on the game map becomes less than a predetermined distance, the device for controlling a motion of a user character may check the slot 1410 of the user character corresponding to the slot attribute of the first wearable item.

That is, when the first wearable item is present on the game map and a user character of a user who wants to obtain the first wearable item approaches the first wearable item within a distance less than the predetermined distance, the device for controlling a motion of a user character may check the slot 1410 corresponding to the first wearable item.

As a result of the check, when there is no item applied to the slot 1410, the device for controlling a motion of a user character may automatically apply the first wearable item to the user character. For example, when the first wearable item is a first helmet, the slot attribute of the first helmet may be helmet, and the device for controlling a motion of a user character may apply the first helmet to the user character based on the absence of an item applied as a helmet of the user character.

In addition, as a result of the check, when a second wearable item having a lower grade attribute than the first wearable item is applied to the slot 1410, the device for controlling a motion of a user character may automatically release the application of the second wearable item to the user character and apply the first wearable item. For example, when the first wearable item is a first helmet of the Mythic grade, the slot attribute of the first helmet may be helmet, the grade attribute of the first helmet may be Mythic, and the device for controlling a motion of a user character may automatically release the application of the second helmet based on the application of the second helmet of the Normal grade as a helmet of the user character, and apply the first helmet.

In addition, as a result of the check, when a third wearable item having a grade attribute higher than or equal to the first wearable item is applied to the slot 1410, the device for controlling a motion of a user character may release the application of the third wearable item to the user character and apply the first wearable item, based on a user input. For example, when the first wearable item is a first helmet of the Normal grade, the slot attribute of the first helmet may be helmet, the grade attribute of the first helmet may be Normal, and a third helmet of the Mythic grade may have been applied as a helmet of the user character. In this case, the device for controlling a motion of a user character may display an interaction image object indicating that an interaction between the user character and the first helmet is possible.

Here, the user may input a user input for applying the first helmet, and the device for controlling a motion of a user character may release the application of the third helmet and apply the first helmet, based on receiving the user input for applying the first helmet.

The device for controlling a motion of a user character may promote convenience of users' gameplay through automatic wearing according to the grade, and also require a strategic choice by considering the effect for each wearable item when approaching an item having the same or lower grade.

In addition, as a result of the check, when the same item as the first wearable item has been applied to the slot 1410, the device for controlling a motion of a user character may additionally apply the first wearable item to the user character to increase a wearing effect of the first wearable item applied to the user character. For example, when the first wearable item is a first helmet, the device for controlling a motion of a user character may automatically increase the wearing effect of the first helmet based on the same first helmet as the first helmet being applied as a helmet of the user character. In this case, the wearing effect of the first wearable item on the user character may increase, and the device for controlling a motion of a user character may indicate that the wearing effect has been increased by displaying an object including a numerical value such as +1 or +2 on an interface displaying a helmet portion of the slot 1410.

In addition, in an embodiment, even when the slot 1410 is empty or when a wearable item of a low grade is applied, the device for controlling a motion of a user character may not automatically apply the first wearable item based on a previously input user setting.

According to an embodiment, the device for controlling a motion of a user character may determine an item selection order for a plurality of users including the user corresponding to the user character, based on a result of the first unit game. For example, in a case in which the first unit game is a one-on-one combat game, the device for controlling a motion of a user character may determine the item selection order by giving a player who lost in the first unit game the first priority, and the player who won in the first unit game the second priority.

In an embodiment, the device for controlling a motion of a user character may receive item selection inputs from the plurality of users based on the item selection order, through an item selection interface 1400 allowing the users to select at least one of a plurality of items 1420. Here, the item selection interface 1400 may display the plurality of items 1420 to the plurality of users simultaneously, and the plurality of users may select an item one by one in the order.

For example, when the first unit game is a one-on-one combat game and the plurality of items 1420 include three items, the user with the first priority may select a second weapon of grade A, and the user with the second priority may select a second weapon of grade C.

In an embodiment, the device for controlling a motion of a user character may distribute the plurality of items 1420 to the plurality of users based on the item selection inputs. For example, the second weapon selected by the user with the first priority, and a first armor of grade B which remains after two items are respectively selected by the user with the first priority and the user with the second priority, may be distributed to the user with the first priority, and the first weapon selected by the user with the second priority may be distributed to the user with the second priority.

In an embodiment, in the second unit game, the device for controlling a motion of a user character may apply the effects of the distributed items to the characters respectively corresponding to the plurality of users, thereby applying, to the user character, the second item distributed to the user corresponding to the user character. That is, the plurality of users may select an item in an order based on a result of the previous unit game, and the device for controlling a motion of a user character may apply the item according to the selection to each character in the next unit game.

As a specific example, in a one-on-one combat game, the item selection interface 1400 in which three items are provided may be provided at the end of the first unit game. Here, according to an embodiment, a user who lost in the first unit game may obtain an item that is first selected by the user, and an item ultimately not selected by anyone, as a second item. Through this, the device for controlling a motion of a user character may provide a possibility of unpredictable and dynamic game progression by providing item selection priority and a plurality of items to a user who is determined to be in a disadvantageous position through the first unit game, and may highlight the importance of strategic item selection. However, the item selection order is not limited thereto.

In addition, in an embodiment, the types of the plurality of items 1420 to be selected in the item selection interface 1400 may be randomly determined. Meanwhile, in another embodiment, the types of the plurality of items 1420 may be determined based on the stats of the characters participating in the game, wearable items that are currently worn, and/or a result of the first unit game.

For example, the plurality of items 1420 may include a wearable item capable of supplementing a stat of any one character participating in the game having the largest difference when compared to the stats of the other characters. As a specific example, when the stat of any one character having the largest difference compared to the stats of the other characters is health, the plurality of items 1420 may include a wearable item having an effect of increasing maximum health.

As another example, the plurality of items 1420 may include an item having a slot attribute corresponding to a slot that is commonly empty for the characters participating in the game. As a specific example, when the helmet slots of the characters participating in the game are all empty, the plurality of items 1420 may include an item having a slot attribute of helmet.

As another example, when a difference in scores of the users determined based on a predetermined criterion in the first unit game exceeds a predetermined range, the plurality of items 1420 may be configured differently for each user. As a specific example, when a first user is eliminated by a unilateral blow in an extremely short time period by a second user, the plurality of items 1420 provided to the first user may include items each having a higher grade than the plurality of items 1420 provided to the second user.

In addition, in the item selection interface 1400, the plurality of items 1420 are displayed at a plurality of positions corresponding to the respective items, and according to the example illustrated in FIG. 14, when three items are displayed, the positions at which the items are displayed may be understood as a first position, a second position, and a third position, respectively, from left to right.

Here, according to an example in which the plurality of items 1420 provided to the first user include items each having a higher grade than the plurality of items 1420 provided to the second user, an A-grade helmet may be provided at the first position to the first user, and a B-grade helmet may be provided at the first position to the second user, such that when the first user selects the item at the first position, the first user obtains the A-grade helmet, and when the second user selects the item at the first position, the second user obtains the B-grade helmet. In addition, a B-grade armor may be provided at the second position to the first user, and a C-grade armor may be provided at the second position to the second user, such that when the first user selects the item at the second position, the first user obtains the B-grade armor, and when the second user selects the item at the second position, the second user obtains the C-grade armor. In addition, a C-grade weapon may be provided at the third position to the first user, and a D-grade weapon may be provided at the third position to the second user, such that when the first user selects the item at the third position, the first user obtains the C-grade weapon, and when the second user selects the item at the third position, the second user obtains the D-grade weapon.

In other words, according to the result of the first unit game, the first user may be provided with the item selection interface 1400 in which an A-grade helmet is displayed at the first position, a B-grade armor is displayed at the second position, and a C-grade weapon is displayed at the third position, and the second user playing with the first user may be provided with the item selection interface 1400 in which a B-grade helmet is displayed at the first position, a C-grade armor is displayed at the second position, and a D-grade weapon is displayed at the third position.

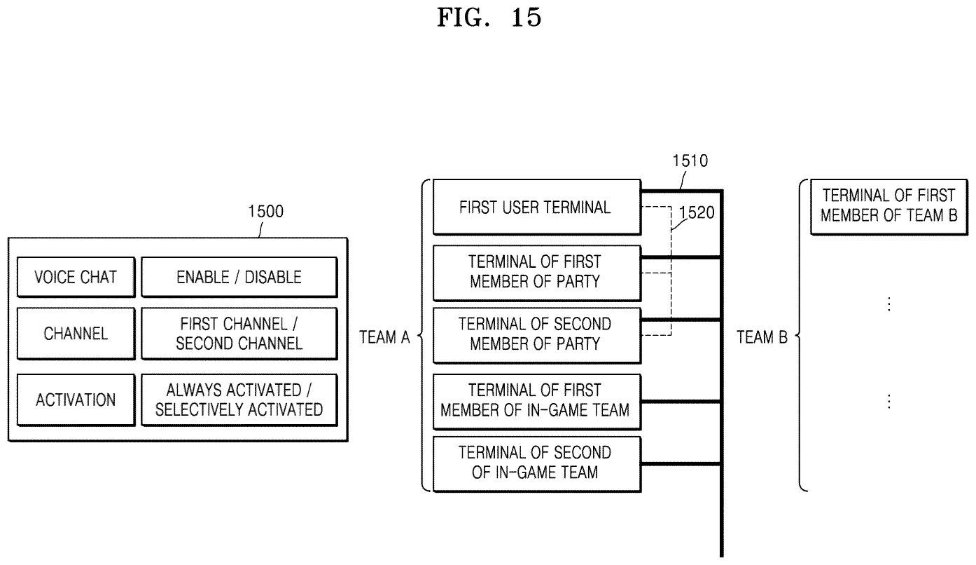

FIG. 15 is a diagram for describing a process of connecting a user to a voice chat channel, according to an embodiment of the present disclosure.

In the present disclosure, the device for controlling a motion of a user character may connect a voice chat channel to a user terminal. Referring back to FIG. 1, the plurality of user terminals 1000 may be connected to each other through a network, and the device for controlling a motion of a user character may implement a voice chat channel by connecting user terminals capable of performing real-time two-way communication based on an established party or team.

Referring to FIG. 15, the device for controlling a motion of a user character may provide each user with a voice chat setting interface 1500.

The user may enable or disable the use of voice chat, and when the use of voice chat is enabled, the user may select a first channel 1520 for voice chat with party members or a second channel 1510 for voice chat with team members, and when the use of voice chat is enabled, the user may select whether to have audio input always activated or selectively activated.

In an embodiment, when the use of voice chat for a first user is enabled, the device for controlling a motion of a user character may receive a channel selection input for selecting any one of the first channel 1520 and the second channel 1510 from the user. As described above, the device for controlling a motion of a user character may receive a channel selection input through the voice chat setting interface 1500.

In addition, when the use of voice chat for the first user is disabled, the device for controlling a motion of a user character may not connect the first user to the first channel 1520 or the second channel 1510.

In an embodiment, when the channel selection input is an input for selecting the first channel 1520, the device for controlling a motion of a user character may identify a second user who constitutes a party with the first user, and connect the first user to a first channel 1510 that supports voice chat between the first user and the second user.

In the present disclosure, the party may include a previously established team, and may be established through selection or invitation within a previously formed friend group.

For example, when a terminal corresponding to the first user is a first user terminal, and terminals corresponding to party members constituting a party with the first user are a first party member terminal and a second party member terminal, the device for controlling a motion of a user character may connect the first user terminal to the first channel 1520, which enables voice chat with the first party member terminal and the second party member terminal.

In addition, in an embodiment, when the channel selection input is an input for selecting the second channel 1510, the device for controlling a motion of a user character may identify a third user who constitutes an in-game team with the first user, and connect the first user to the second channel 1510 that supports voice chat between the first user and the third user.

For example, when a terminal corresponding to the first user is a first user terminal, and terminals corresponding to team members constituting an in-game team with the first user are a first party member terminal, a second party member terminal, a first in-game team member terminal, a second in-game team member terminal, etc., which constitute team A, the device for controlling a motion of a user character may connect the first user terminal to the second channel 1510, which enables voice chat with all user terminals constituting team A.

Here, in general, party members constituting a party play as the same in-game team, and thus, a terminal group connected to the second channel 1510 may include a terminal group connected to the first channel 1520, but is not limited thereto.

In addition, in an embodiment, the device for controlling a motion of a user character may activate audio input of the first user connected to the first channel 1510 or the second channel 1510 only when a predetermined activation condition is satisfied.

According to an embodiment, when the audio input is set to be always activated, the audio input of the first user may be activated without a separate condition.

On the contrary, according to an embodiment, when the audio input is set to be selectively activated, the audio input of the first user may be activated only when the predetermined activation condition is satisfied. Here, the predetermined activation condition may be to activate the audio input only while performing audio activation through a separate input such as an input of a particular key on a keyboard or a selection of an audio activation object displayed on a touch screen.

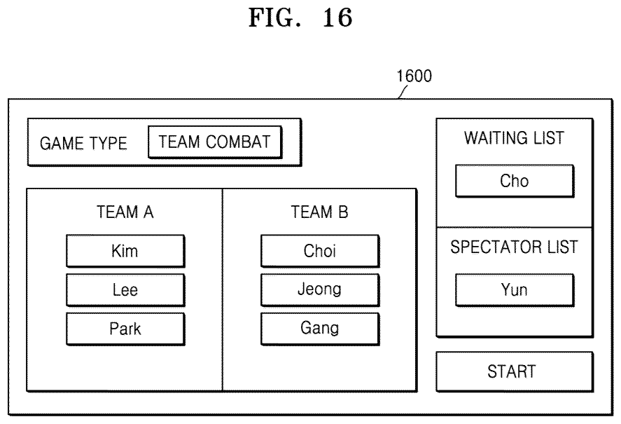

FIG. 16 is a diagram for describing a user setting interface for receiving a user setting input, according to an embodiment of the present disclosure.

In the present disclosure, the device for controlling a motion of a user character may provide a user setting input interface 1600. The user setting input interface 1600 according to an embodiment may be provided to improve the convenience and interest of users playing the game.

In an embodiment, the device for controlling a motion of a user character may obtain a user setting input for selecting at least one of a game type, a member of a party, a member of an in-game team, and a spectating member, from a first user through the user setting input interface 1600.

For example, the first user may be a master of a user-set game, and may select a game type such as one-on-one combat or team combat. In addition, the first user may select a team member, and a user waiting to be selected for team composition may be included in a waiting list.

In addition, a user included in a spectator list at the start of a game may spectate the gameplay of other users. A user included in the spectator list does not directly participate in the game, but may observe the game and may learn from or enjoy strategies and play styles of other users.

In an embodiment, the device for controlling a motion of a user character may apply a user setting input to a user-set game including at least one unit game.

For example, in the unit game that begins according to the start of the game, a game of a selected type such as one-on-one combat or team combat is played according to a user setting input from the first user, and in the unit game, composition of a team and a spectator list may be determined according to a user setting input through the user setting input interface 1600.

In an embodiment, when the first user uses voice chat and selects the second channel 1510, the first user may perform voice chat with team members according to a user setting input.

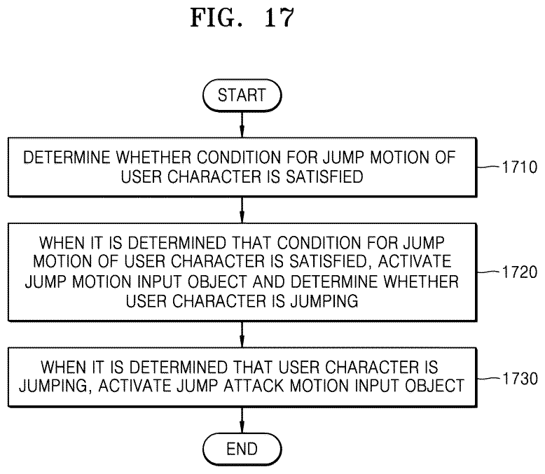

FIG. 17 is an example of a method of controlling a motion of a user character, according to an embodiment of the present disclosure.

Referring to FIG. 17, in operation 1710, the device for controlling a motion of a user character may determine whether a condition for a jump motion of a user character is satisfied. Here, the condition for the jump motion may include that the user character is airborne.

In an embodiment, that the user character is airborne may include that the user character is jumping, that the user character is being knocked back, and that the user character is in an unsafe zone.

In operation 1720, when it is determined that the condition for the jump motion of the user character is satisfied, the device for controlling a motion of a user character may activate a jump motion input object and determine whether the user character is jumping.

In operation 1730, when it is determined that the user character is jumping, the device for controlling a motion of a user character may activate a jump attack motion input object.

In an embodiment, the device for controlling a motion of a user character may receive a jump motion input through a jump motion input object.

Here, when the user character is not jumping, the device for controlling a motion of a user character may control the user character to jump, and when the user character is jumping, may control the user character to perform a multi-jump.

In an embodiment, the device for controlling a motion of a user character may convert an attack motion input object into a jump attack motion input object.

In an embodiment, the device for controlling a motion of a user character may receive a jump attack motion input through the jump attack motion input object, and control the user character to perform a jump attack. Here, the device for controlling a motion of a user character may set, as a target of the jump attack, an enemy closest to the user character.

The device for controlling a motion of a user character may provide a first interface that displays the user character, a game map, and at least one in-game object from a predetermined viewpoint.

In an embodiment, the device for controlling a motion of a user character may set attribute information about each in-game object. Here, when the user character is obscured by an in-game object, the device for controlling a motion of a user character may provide a first interface that displays the user character by using a display effect corresponding to the attribute information.

The predetermined viewpoint according to an embodiment may include a third-person viewpoint in which, when the user character is not moving, the user character is located at the center of the first interface, and when the user character is moving in one direction, the viewpoint moves in one direction with a predetermined time interval from the movement of the user character.

The in-game objects according to an embodiment may include a character cloaking object, and here, the device for controlling a motion of a user character may provide a first interface that further displays another character that is not in an ally state with the user character based on the location of the other character and the predetermined viewpoint, but does not display the other character when the user character is located outside the cloaking object and the other character is located inside the cloaking object.

In another embodiment, when both the user character and the other character are located inside the cloaking objects, the device for controlling a motion of a user character may provide a first interface that displays the other character based on the distance between the user character and the other character.

In an embodiment, the device for controlling a motion of a user character may provide a second interface that displays a mini-map corresponding to the game map and a first character icon on the mini-map corresponding to the user character.

Here, the device for controlling a motion of a user character may provide the second interface that displays a second character icon corresponding to another character that is not in an ally state with the user character, based on the distance between the user character and the other character and the direction in which the user character is facing.

In the present disclosure, the device for controlling a motion of a user character may apply a first item to a user character based on the distance between the user character and the item within a first unit game. In addition, the device for controlling a motion of a user character may apply a second item to a user character based on a result of the first unit game and an item selection input from each user.

The first item according to an embodiment may include a first wearable item, and when the distance between the location of the user character on the game map and the location of the first wearable item on the game map becomes less than a predetermined distance, the device for controlling a motion of a user character may check a slot of the user character corresponding to the slot attribute of the first wearable item.

As a result of the check, when there is no item applied to the slot, the device for controlling a motion of a user character may automatically apply the first wearable item to the user character.

In addition, as a result of the check, when a second wearable item having a lower grade attribute than the first wearable item is applied to the slot, the device for controlling a motion of a user character may automatically release the application of the second wearable item to the user character and apply the first wearable item.

In addition, as a result of the check, when a third wearable item having a grade attribute higher than or equal to the first wearable item is applied to the slot, the device for controlling a motion of a user character may release the application of the third wearable item to the user character and apply the first wearable item, based on a user input.

In addition, in an embodiment, the device for controlling a motion of a user character may determine an item selection order for a plurality of users including the user corresponding to the user character, based on a result of the first unit game. In addition, the device for controlling a motion of a user character may receive item selection inputs from the plurality of users based on the item selection order, through an item selection interface allowing the users to select at least one of a plurality of items.

The device for controlling a motion of a user character may distribute the plurality of items to the plurality of users based on the item selection inputs. Here, in the second unit game, the device for controlling a motion of a user character may apply the effects of the distributed items to the characters respectively corresponding to the plurality of users, thereby applying, to the user character, the second item distributed to the user corresponding to the user character.

In the present disclosure, when the use of voice chat for a first user is enabled, the device for controlling a motion of a user character may receive a channel selection input for selecting any one of a first channel and a second channel from the user.

In addition, when the use of voice chat for the first user is disabled, the device for controlling a motion of a user character may not connect the first user to the first channel or the second channel.

In an embodiment, when the channel selection input is an input for selecting the first channel, the device for controlling a motion of a user character may identify a second user who constitutes a party with the first user, and connect the first user to the first channel that supports voice chat between the first user and the second user.

In addition, in an embodiment, when the channel selection input is an input for selecting the second channel, the device for controlling a motion of a user character may identify a third user who constitutes an in-game team with the first user, and connect the first user to the second channel that supports voice chat between the first user and the third user.

In an embodiment, the device for controlling a motion of a user character may activate audio input of the first user connected to the first channel or the second channel only when a predetermined activation condition is satisfied.

In an embodiment, the device for controlling a motion of a user character may obtain, from a first user, a user setting input for selecting at least one of a game type, a member of a party, a member of an in-game team, and a spectating member. Here, the device for controlling a motion of a user character may apply a user setting input to a user-set game including at least one unit game.

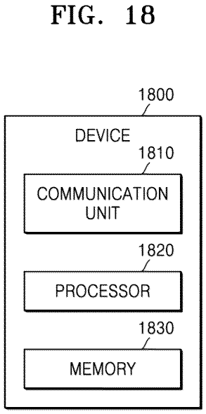

FIG. 18 is a block diagram of a device for controlling a motion of a user character, according to an embodiment of the present disclosure.

Referring to FIG. 18, a device 1800 for controlling a jump motion of a user character (hereinafter, referred to as “device”) may include a communication unit 1810, a processor 1820, and a memory 1830. FIG. 18 illustrates the device 1800 including only the components associated with an embodiment. Thus, it would be understood by those of skill in the art that other general-purpose components may be further included in addition to those illustrated in FIG. 18.

The communication unit 1810 may include one or more components for performing wired/wireless communication with other nodes. For example, the communication unit 1810 may include at least one of a short-range communication unit (not shown), a mobile communication unit (not shown), and a broadcast receiver (not shown).

The memory 1830 is hardware for storing various pieces of data processed by the device 1800, and may store a program for the processor 1820 to perform processing and control. The memory 1830 may store user information, character information, and/or map information.

The memory 1830 may include random-access memory (RAM) such as dynamic RAM (DRAM) or static RAM (SRAM), read-only memory (ROM), electrically erasable programmable ROM (EEPROM), a compact disc-ROM (CD-ROM), a Blu-ray or other optical disk storage, a hard disk drive (HDD), a solid-state drive (SSD), or flash memory.

The processor 1820 controls the overall operation of the device 1800. For example, the processor 1820 may execute programs stored in the memory 1830 to control the overall operation of an input unit (not shown), a display (not shown), the communication unit 1810, the memory 1830, and the like. The processor 1820 may execute programs stored in the memory 1830 to control at least some of the operations of the device for controlling a motion of a user character described above with reference to FIGS. 1 to 17.

The processor 1820 may be implemented by using at least one of application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, and other electrical units for performing functions.

In an embodiment, the device 1800 may be a mobile electronic device. For example, the device 1800 may be implemented as a smart phone, a tablet PC, a PC, a smart TV, a personal digital assistant (PDA), a laptop computer, a media player, a navigation system, a camera-equipped device, and other mobile electronic devices. In addition, the device 1800 may be implemented as a wearable device having a communication function and a data processing function, such as a watch, glasses, a hair band, a ring, or the like.

An embodiment of the present disclosure may be implemented as a computer program that may be executed through various components on a computer, and such a computer program may be recorded in a computer-readable medium. In this case, the medium may include a magnetic medium, such as a hard disk, a floppy disk, or a magnetic tape, an optical recording medium, such as a CD-ROM or a digital video disc (DVD), a magneto-optical medium, such as a floptical disk, and a hardware device specially configured to store and execute program instructions, such as ROM, RAM, or flash memory.

In addition, the computer program may be specially designed and configured for the present disclosure or may be well-known to and usable by those skilled in the art of computer software. Examples of the computer program may include not only machine code, such as code made by a compiler, but also high-level language code that is executable by a computer by using an interpreter or the like.

According to an embodiment, the method according to various embodiments of the present disclosure may be included in a computer program product and provided. The computer program product may be traded as commodities between sellers and buyers. The computer program product may be distributed in the form of a machine-readable storage medium (e.g., a CD-ROM), or may be distributed online (e.g., downloaded or uploaded) through an application store (e.g., Play Store™) or directly between two user devices. In a case of online distribution, at least a portion of the computer program product may be temporarily stored in a machine-readable storage medium such as a manufacturer's server, an application store's server, or a memory of a relay server.

What is claimed is:

1. A method, performed by an electronic device, of applying an item to a character in a game, the method comprising:
controlling progress of a first unit game among a plurality of unit games in which a plurality of users participate;
providing a first user terminal of a first user among the plurality of users with an item selection interface through which at least one of a plurality of items comprising an odd number of items is selectable;
receiving a selection input for a first item among the plurality of items, from the first user terminal through the item selection interface; and
applying the first item to a first user character of the first user based on the selection input for the first item.

2. The method of claim 1, further comprising determining an item selection order for the plurality of users based on a result of the first unit game.

3. The method of claim 2, further comprising:
after the receiving of the selection input for the first item from the first user terminal, receiving, based on the item selection order, a selection input for a second item among the plurality of items other than the first item, from a second user terminal of a second user among the plurality of users; and
applying the second item to a second user character of the second user based on the selection input for the second item.

4. The method of claim 1, wherein the plurality of items displayed through the item selection interface are randomly configured, or are configured based on at least one of a stat of the user character, an item worn by the user character, and a result of the first unit game.

5. The method of claim 3, wherein the applying the first item comprises applying, to the first user character, the first item selected by the first user, and further applying, to the first user character, items other than the first item and the second item among the plurality of items, based on the result of the first unit game.

6. The method of claim 1, wherein the applying of the first item comprises applying an effect of the first item to the first user character in a second unit game among the plurality of unit games, which is performed after the first unit game.

7. The method of claim 1, further comprising applying a third item to the first user character based on a distance between the first user character and the third item, in the first unit game.

8. The method of claim 7, wherein the third item comprises a first wearable item, the applying of the third item comprises applying the first wearable item to the first user character based on checking a slot of the first user character, and the applying of the first wearable item comprises, based on the checking of the slot indicating absence of an item applied to the slot, automatically applying the first wearable item to the first user character, based on the checking of the slot indicating that a second wearable item having a lower grade attribute than a grade attribute of the first wearable item is applied to the slot, automatically release the application of the second wearable item to the first user character and applying the first wearable item, and based on the checking of the slot indicating that a third wearable item having a grade attribute higher than or identical to the grade attribute of the first wearable item is applied to the slot, releasing, based on receiving an item change input from the first user, the application of the third wearable item to the first user character and applying the first wearable item.

9. An electronic device for applying an item to a character in a game, the electronic device comprising:
a memory storing at least one program; and
a processor configured to execute the at least one program to perform an operation,
wherein the processor is further configured to control progress of a first unit game among a plurality of unit games in which a plurality of users participate, provide a first user terminal of a first user among the plurality of users with an item selection interface through which at least one of a plurality of items comprising an odd number of items is selectable, receive a selection input for a first item among the plurality of items, from the first user terminal through the item selection interface, and apply the first item to a first user character of the first user based on the selection input for the first item.

10. The electronic device of claim 9, wherein the processor is further configured to determine an item selection order for the plurality of users based on a result of the first unit game.

11. The electronic device of claim 10, wherein the processor is further configured to, after the receiving of the selection input for the first item from the first user terminal, receive, based on the item selection order, a selection input for a second item among the plurality of items other than the first item, from a second user terminal of a second user among the plurality of users, and apply the second item to a second user character of the second user based on the selection input for the second item.

12. The electronic device of claim 9, wherein the plurality of items displayed through the item selection interface are randomly configured, or are configured based on at least one of a stat of the user character, an item worn by the user character, and a result of the first unit game.

13. The electronic device of claim 11, wherein the applying the first item comprises applying, to the first user character, the first item selected by the first user, and further applying, to the first user character, items other than the first item and the second item among the plurality of items, based on the result of the first unit game.

14. The electronic device of claim 9, wherein the applying of the first item comprises applying an effect of the first item to the first user character in a second unit game among the plurality of unit games, which is performed after the first unit game.

15. The electronic device of claim 9, wherein the processor is further configured to apply a third item to the first user character based on a distance between the first user character and the third item, in the first unit game.

16. The electronic device of claim 15, wherein the third item comprises a first wearable item,
the applying of the third item comprises applying the first wearable item to the first user character based on checking a slot of the first user character, and
the applying of the first wearable item comprises, based on the checking of the slot indicating absence of an item applied to the slot, automatically applying the first wearable item to the first user character, based on the checking of the slot indicating that a second wearable item having a lower grade attribute than a grade attribute of the first wearable item is applied to the slot, automatically release the application of the second wearable item to the first user character and applying the first wearable item, and based on the checking of the slot indicating that a third wearable item having a grade attribute higher than or identical to the grade attribute of the first wearable item is applied to the slot, releasing, based on receiving an item change input from the first user, the application of the third wearable item to the first user character and applying the first wearable item.

17. A non-transitory computer-readable recording medium having recorded thereon a program for causing a computer to execute the method of claim 1.
